(19) United States
(12) Patent Application Publication
(10) Pub. No.: US 2025/0278702 A1
(43) Pub. Date: Sep. 4, 2025

(54) Methods And Computing Systems for Objective-Based Scheduling Of Vehicle Servicing

(71) Applicant: Ansik Inc., Toronto (CA)

(72) Inventors: Christopher D. Mah, North York (CA); Shiva Bhardwaj, Toronto (CA)

(21) Appl. No.: 18/821,259

(22) Filed: Aug. 30, 2024

Related U.S. Application Data
(60) Provisional application No. 63/559,534, filed on Feb. 29, 2024.

(51) Int. Cl. G06Q 10/20; G07C 5/00; G07C 5/08

(52) U.S. Cl. CPC G06Q 10/20; G07C 5/0816; G07C 5/085; G07C 5/008

(57) ABSTRACT

Systems and methods for objective-based scheduling of vehicle servicing include: storing an objective function for prioritizing vehicle availability and vehicle maintenance cost reduction; receiving vehicle telemetry data for a vehicle; generating a vehicle service event forecast at least partially based on the vehicle telemetry data; and scheduling a vehicle service event for the vehicle related to the vehicle telemetry data at least partially based on the vehicle service event forecast and the objective function.

### CROSS-REFERENCE TO RELATED APPLICATIONS

The present application claims priority from U.S. Provisional application Ser. No. 63/559,534, filed on Feb. 29, 2024.

### TECHNICAL FIELD

The present disclosure relates to vehicle maintenance, and, in particular, to methods and computing systems for objective-based scheduling of vehicle servicing.

### BACKGROUND

In many industrial settings it is necessary to employ a number of identical machines in order to carry on a business. The simplest example of this is a fleet of vans or trucks, but the methods disclosed here might also apply to industrial robots, medical equipment or even home appliances.

In the situation described, manufacturers often prescribe a schedule of maintenance according to time or some measure of usage, such as mileage or engine hours. Such schedules are designed to ensure that maintenance is undertaken at an appropriate time according to some easily observed or known criterion. An appropriate schedule recommends maintenance at time or usage intervals that prolong the life of the machine, or reduce some risk, and do not incur an undue expense given the benefits which are likely to be gained.

However, no two machines or vehicles will be used in exactly the same way, and simple measures of use, or health may fail to capture these differences. As a result, machines or vehicles may be over maintained, or under maintained resulting in waste or undue risk.

Different types of waste can occur; some are of a discretionary nature and some are limited by resources.

Most simply, management might decide to spend less on maintenance in order to save in the short term and accept any future consequences. Or low levels of maintenance might be the result of a shortage of technicians or of parts. In such situations, it is beneficial to have processes which ensure that the available effort produces the greatest economic benefit. For example, a simple repair that prolongs new vehicle life will be more beneficial than a complex repair that prolongs the life of an older vehicle by a small amount. Decisions of this type can be described as triage.

Similar decisions must be made when deciding when to replace an old vehicle with a new one, rather than replacing an expensive part. Since components degrade at different rates, it would be inefficient to replace a single expensive aging component when the remaining components in the machine have much shorter expected lifetimes.

As another example of resource matching, if it is known that the design of a certain machine and the conditions of operation result in failure of certain components more often than normal, these parts could be purchased in bulk.

Therefore there is a need to generate suitable measures of health and wear, and methods which use such measures to match machines to resources in real time, providing economic benefits. Similar reasoning can also be used with predictive signs such as diagnostic trouble codes or algorithm results based on other telematics data.

### SUMMARY

In accordance with a first aspect of the present disclosure, there is provided a computer-implemented method for objective-based scheduling of vehicle servicing, comprising: storing an objective function for prioritizing vehicle availability and vehicle maintenance cost reduction; receiving vehicle telematics data for a vehicle; generating a vehicle service event forecast at least partially based on the vehicle telematics data; and scheduling a vehicle service event for the vehicle related to the vehicle telematics data at least partially based on the vehicle service event forecast and the objective function.

In some or all exemplary embodiments of the first aspect, the vehicle telematics data includes one or more fault code events corresponding to one or more fault codes.

In some or all exemplary embodiments of the first aspect, the vehicle telematics data includes metrics indicative of wear of one or more components of the vehicle.

In some or all exemplary embodiments of the first aspect, the vehicle telematics data includes battery health data corresponding to a health state of a battery of the vehicle.

In some or all exemplary embodiments of the first aspect, the objective function is a weighted function of cost over time.

In some or all exemplary embodiments of the first aspect, the scheduling includes adjusting a scheduled service event for one or more issues identified in the vehicle telematics data.

In some or all exemplary embodiments of the first aspect, a check of a component associated with the issue is scheduled for the scheduled service event.

In some or all exemplary embodiments of the first aspect, the scheduled service event is scheduled earlier or later.

In a second aspect of the present disclosure, there is provided a computing system for objective-based scheduling of vehicle servicing, comprising: one or more processors; and a memory storing machine-executable instructions that, when executed by the one or more processors, cause the computing system to: store an objective function for vehicle availability and vehicle maintenance cost reduction; receive vehicle telematics data for a vehicle; generate a vehicle service event forecast at least partially based on the vehicle telematics data; and schedule a vehicle service event for the vehicle related to the vehicle telematics data at least partially based on the vehicle service event forecast and the objective function.

In some or all exemplary embodiments of the second aspect, the vehicle telematics data includes one or more fault code events corresponding to one or more fault codes.

In some or all exemplary embodiments of the second aspect, the vehicle telematics data includes metrics indicative of wear of one or more components of the vehicle.

In some or all exemplary embodiments of the second aspect, the vehicle telematics data includes battery health data corresponding to a health state of a battery of the vehicle.

In some or all exemplary embodiments of the second aspect, the objective function is a weighted function of cost over time.

In some or all exemplary embodiments of the second aspect, the scheduling includes adjusting a scheduled service event for one or more issues identified in the vehicle telematics data.

In some or all exemplary embodiments of the second aspect, a non-transitory machine-readable medium is provided having tangibly stored thereon machine-executable instructions that, when executed by the one or more processors, cause the computing system to schedule a check of a component associated with the issue for the scheduled service event.

In some or all exemplary embodiments of the second aspect, the scheduled service event is scheduled earlier or later.

In a third aspect of the present disclosure, there is provided a non-transitory machine-readable medium having tangibly stored thereon executable instructions for execution by one or more processors, wherein the executable instructions, in response to execution by the one or more processors, cause the one or more processors to perform the method of any one of the method claims above.

In another aspect of the present disclosure, a computer-implemented method for providing a vehicle service recommendation comprises: receiving a vehicle telemetric indication corresponding to a fault code, receiving badness data for a plurality of outcomes associated to the fault code, each outcome being associated to one of a plurality of groups, the plurality of groups comprising at least a first group associated to a first action of a plurality of actions and a second group associated to a second action of the plurality of actions, receiving, from a database, probability data corresponding to a probability of each outcome, ascribing a badness value to each of the plurality of outcomes based on the badness data and the probability data, determining a total badness score for at least the first group and the second group based on the badness value ascribed to each outcome, determining a lowest badness group based on the total badness score, and outputting an indication corresponding to the action, of the plurality of actions, associated to the lowest badness group, to provide the vehicle service recommendation.

In embodiments, the receiving of the badness data comprises obtaining a plurality of indications, each indication corresponding to a numeric value and being associated to one of two or more badness factors, the badness factors comprising a cost of downtime associated to the fault code and a cost of repair associated to the fault code, and storing the plurality of indications in the database.

In embodiments, the plurality of actions comprises at least two of a vehicle repair action corresponding to executing a repair associated with the fault code, a delay action corresponding to delaying the vehicle repair associated with the fault code for a predetermined time period, and a defer action corresponding to executing the vehicle repair associated with the fault code during a scheduled shop visit.

In another aspect, a system for providing a vehicle service recommendation comprises a processor and a non-transitory storage medium operatively connected to the processor, the non-transitory storage medium comprising computer readable instructions, the processor, upon executing the computer readable instructions, being configured for receiving a vehicle telemetric indication corresponding to a fault code, receiving badness data for a plurality of outcomes associated to the fault code, each outcome being associated to one of a plurality of groups, the plurality of groups comprising at least a first group associated to a first action of a plurality of actions and a second group associated to a second action of the plurality of actions, receiving, from a database, probability data corresponding to a probability of each outcome, ascribing a badness value to each of the plurality of outcomes based on the badness data and the probability data, determining a total badness score for at least the first group and the second group based on the badness value ascribed to each outcome, determining a lowest badness group based on the total badness score, and outputting an indication corresponding to the action, of the plurality of actions, associated to the lowest badness group, to provide the vehicle service recommendation.

Other aspects and features of the present disclosure will become apparent to those of ordinary skill in the art upon review of the following description of specific implementations of the application in conjunction with the accompanying figures.

### BRIEF DESCRIPTION OF THE DRAWINGS

Reference will now be made, by way of example, to the accompanying drawings which show example embodiments of the present application, and in which:

FIG. 1 is a schematic diagram illustrating a computing system for objective-based scheduling of vehicle servicing and its operating environment in accordance with example embodiments described herein.

FIG. 2 is a flow chart of a general method of objective-based scheduling of vehicle maintenance in accordance with example embodiments described herein.

FIGS. 3A and 3B illustrate two different scenarios of service objectives for organizations.

FIGS. 4A and 4B illustrate two different scenarios of service priorities for organizations.

FIG. 5 shows the number of preventative service events prior to non-repair visits and repair visits to service centers for compressed natural gas vehicles.

FIG. 6 shows the number of preventative service events prior to non-repair visits and repair visits to service centers for gas-powered vehicles.

FIG. 7 is a graph of fault code timings before and after an unplanned service event.

FIG. 8 is a graph of fault code timings before and after an unplanned service event.

FIG. 9 is a graph of fault code timings before and after a preventative maintenance service event.

FIG. 10 is a schematic diagram of an exemplary exhaust system of a vehicle for which fault codes may be generated.

FIG. 11 shows a graph of cluster centers.

FIG. 12 is a graph of acceleration vs. time showing braking events.

FIG. 13 shows various components of a brake assembly.

FIG. 14 shows a distribution of dissipation values experienced by braking assemblies of vehicles.

FIG. 15 shows a distribution of brake service mileages corresponding to the dissipation values of FIG. 14.

FIG. 16 shows various physical and logical components of the computing system for objective-based scheduling of vehicle servicing of FIG. 1 in accordance with some example embodiments described herein.

FIG. 17 shows exemplary possible scenarios following the presence of a fault code or absence thereof.

FIG. 18 shows the scenarios of FIG. 17 grouped into 4 groups.

Similar reference numerals may have been used in different figures to denote similar components. Unless otherwise specifically noted, articles depicted in the drawings are not necessarily drawn to scale.

### DETAILED DESCRIPTION OF EXAMPLE EMBODIMENTS

The present disclosure is made with reference to the accompanying drawings, in which embodiments are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although such functions are illustrated separately for ease of explanation herein. Different devices may have different designs, such that although some devices implement some functions in fixed function hardware, other devices may implement such functions in a programmable processor with code obtained from a machine-readable medium. Lastly, elements referred to in the singular may be plural and vice versa, except wherein indicated otherwise either explicitly or inherently by context.

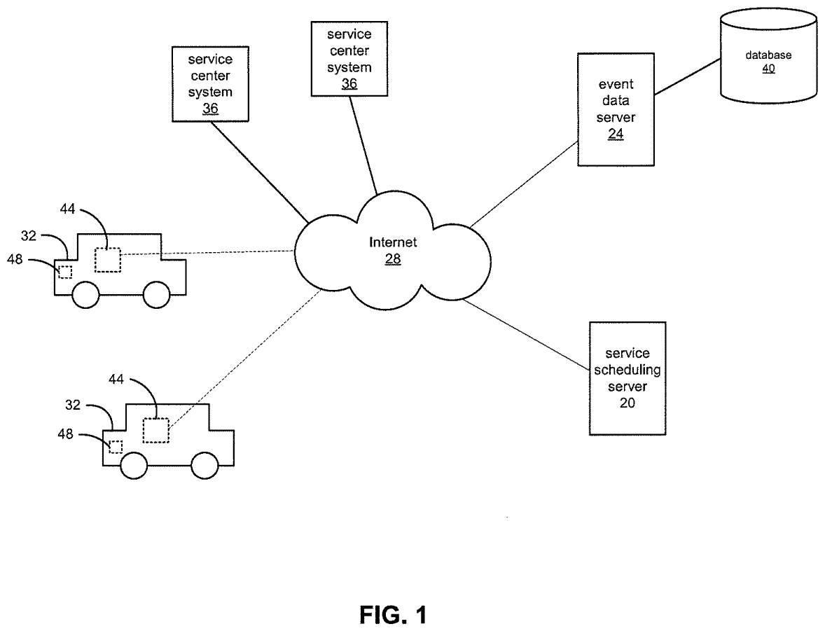

FIG. 1 shows a service scheduling server 20 in accordance with an embodiment and its operating environment.

The service scheduling server 20 communicates with an event data server 24 over a data communications network such as the Internet 28. The event data server 24 is in communication with a set of vehicles 32 and a set of service center systems 36.

During operation of the vehicles 32, fault codes can be generated by onboard systems of the vehicles 32. These fault codes can correspond to, for example, fluid levels, brake performance, brake state, engine performance, etc.

Each of the vehicles 32 has a control module 44 connected to various components 48 of the vehicle 32. The components 48 can be electrical and can generate the fault codes. The control module 44 can transmit fault code notifications corresponding to these fault codes to the event data server 24. The fault code notifications can be sent at the time that the fault codes are generated, intermittently transmitted, or can be sent with any particular frequency or timing as suitable.

In turn, the event data server 24 registers fault code events corresponding to the fault code notifications transmitted by the vehicles 32 in a database 40. The data for the fault code events can include the fault codes, the time at which the fault code was registered by the control module 44 of the corresponding vehicles 32, and other operating conditions of the vehicle 32.

The service center systems 36 notify the service scheduling server 20 of the availability of service time (e.g., vehicle bays, mechanics, etc.), as well as vehicle parts. The service scheduling server 20 registers these parameters in the database 40.

The service scheduling server 20 also maintains an objective function that may include one or more parameters. The objective function is designed to reflect the objectives of the organization regarding vehicle availability and vehicle service costs. In some embodiments, the objective function can include priority values that indicate the weights of different factors in the objective function. The objective function and/or priority values are provided via any suitable interface by a human.

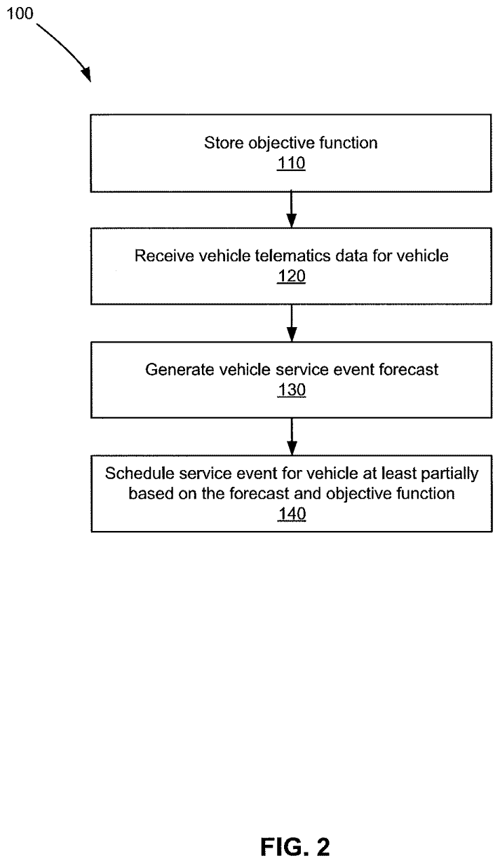

FIG. 2 shows a general method 100 of objective-based scheduling of vehicle servicing in accordance with an embodiment of the disclosure. The method 100 commences with the storing of an objective function for vehicle availability and vehicle maintenance cost (110). These values can be received from a user in any suitable manner, such as via a web interface, an application GUI, a command line interface, etc.

A notification for at least one fault code event is received (120). The notification for the fault code event can be received from the event data server 24 synchronously of when the notification is received by the event data server 24. Alternatively, the event data server 24 can send the notification to the service scheduling server 20 asynchronously, such as, for example, in batches for a number of vehicles periodically.

A vehicle service event forecast is generated for a vehicle at least partially based on the fault code event(s) received for the vehicle (130). The forecast can include the projected probability of failure of the vehicle as a result of the issue underlying the fault code.

A service event is then scheduled at least partially based on the forecast and the objective function maintained by the service scheduling server 20 (140). The service scheduling server 20 can retrieve a service schedule set for the vehicle to determine if the service schedule should be revisited in view of the forecast and the objective function. In one example, if it is projected in the forecast that a detected fault code for the vehicle will likely result in a vehicle failure shortly after a scheduled service event, an inspection can be performed during the scheduled service event to determine if the vehicle should be serviced to address a potential failure related to the fault code.

The determination of whether to or how to revise the service schedule is at least partially based on the objective function stored.

In order to establish the objective function, an analysis is performed to determine the factors that may limit the achievement of a desirable outcome. For example, there could be a shortage of technicians or parts. It might be difficult generate efficient schedules because of competing demands for equipment. Failures of training or diagnostics might lead to shop visits which fail to remedy known symptoms. Informal decision making might lead to over-maintenance of certain systems such as brakes.

The risk preferences for the fleet are determined. For example, the operational requirements of a fire truck mean that it is especially undesirable if the vehicle fails to start, as the need to have the firetruck available to fight fires is typically critical. This might justify routinely replacing batteries well before any failure is likely to occur. That is, vehicle availability has a high priority value in this scenario.

The establishing of an objective function is generally performed prior to their storage at 110.

120 to 140 are typically performed in real or nearly real time as vehicles are used and maintained in the field and vehicle telematics data is received from the vehicles. Vehicle telematics data includes, but is not limited to, fault codes, health scores, wear measures and other algorithm series.

The vehicle service event forecast generated at 130 is used, along with the objective function established at 110, to schedule service events.

The recommendation step addresses the actual actions to be taken in response to predictive signs in the vehicle telematics data, such as diagnostic trouble codes, algorithm results and measures of wear. These might be specifically determined by triage of issues or vehicles, time appropriate scheduling of services or repairs, and consolidation of service visits.

By analyzing the vehicle telematics data and generating a vehicle service event forecast from the vehicle telematics data, and by scheduling service events at least partially based on the vehicle service event forecast and the previously established objective function, the servicing of vehicles can be tailored to the priorities for the organization.

In this disclosure is presented a system and methods for accomplishing this using measures which are predictive, in the sense that observing these measures give information about the chance of imminent failure, or the eventual cost of ownership of the machine or vehicle.

It will be clear to those skilled in the art that the outcome of this method need not be optimal in order to be useful. To provide benefits, it need only help to guide the users away from procedures which are clearly wasteful.

Methods for matching of maintenance resources to prognostic signs using specific techniques such as triage and visit consolidation are also disclosed. Finally, the method disclosed here includes an interactive presentation step to facilitate development of a practical workflow.

### Organization Objectives

Organizations performing fleet management may have two kinds of broad objectives.

The first objective is to prioritize availability. This is the situation where the marginal cost (financial or in some measured utility-such as putting out fires) of downtime is much higher than the cost of any maintenance.

The second objective to prioritize might be cost control. In this case, it might be acceptable to reduce the capacity of the fleet temporarily because the cost of downtime, or slow turnaround in the shop is less important than controlling maintenance cost.

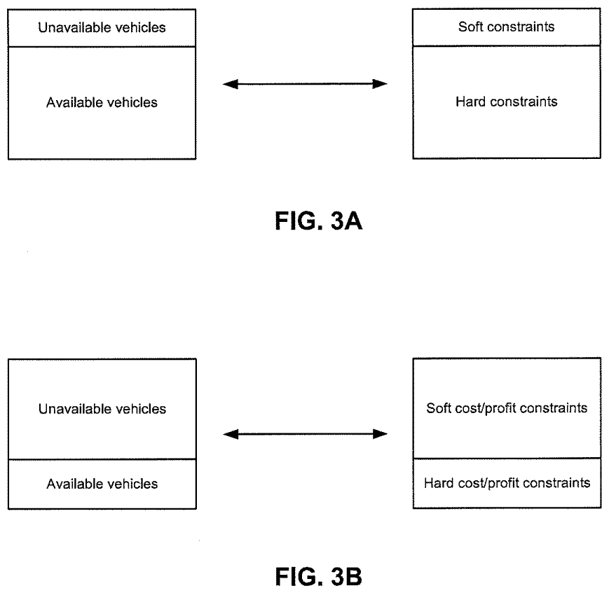

FIGS. 3A and 3B show situations with different fleet management objectives for fleet availability and cost. In FIG. 3A, it is a high priority to keep uptime high regardless of cost, whereas in FIG. 3B, there is greater concern with overall profit and loss, with greater tolerance for varying availability of vehicles. The size of the area for cost constraint reflects the relative importance of the constraint in the calculation. When availability is prioritized, this means that the goal is to keep a maximum fraction of available vehicles, with cost constraints being less important. Conversely, if profit and loss are prioritized it might be acceptable to reduce the number of available vehicles (capacity) in the fleet temporarily in order to control costs. Not shown here, are capital depreciation costs when an excessive number of unused vehicles are present.

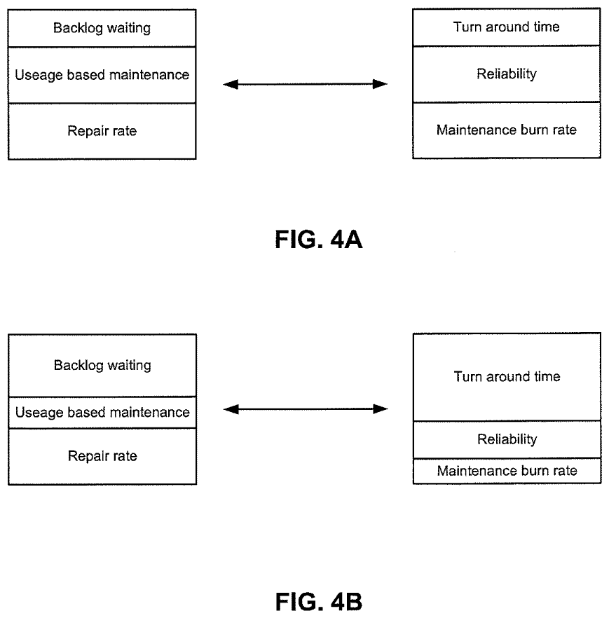

FIGS. 4A and 4B show situations that might be expected in service centers for fleets with different fleet management objectives for fleet reliability and cost. In FIG. 4A, high priority is given to keep uptime high regardless of cost, whereas in FIG. 4B, more concern is provided to overall profit and loss with greater tolerance for varying availability of vehicles. This means when availability is prioritized that turn around time will be less, and reliability will be greater, at the expense of higher maintenance costs. As noted in the text, turn around time and shop visit conservation may compete.

Baseline wear is the underlying tendency of the vehicles to break down, under ‘normal’ use, which is determined by the age and type of vehicles and how they are used.

A second factor is the maintenance policy of the fleet according to its objectives and the effectiveness of the policy. For example, if availability is prioritized, usage based, discretionary maintenance might be performed more often.

In addition, unplanned shop visits might be minimized by performing extra checks for problems while the vehicle is in the shop (found-during-visit repairs, and not being driven (performed-during-driver-report preventive maintenance), and trying to minimize turn-around time.

Another way to say this, is that prioritizing availability implies a more ‘aggressive’ maintenance policy. It is expected that a more aggressive maintenance policy will result in higher reliability, but also a larger maintenance burn rate.

Finally, a third factor is the availability of shop resources. If shop resources (or maintenance spend) are limited, then:
(i) minimizing turn-around time, and
(ii) minimizing future visits via found-during-visit repairs and performed-during-driver-report preventative maintenance, or in response to vehicle telematics data, are competing objectives.

Each of (i) and (ii) require shop time, so if there is a shortage of mechanics, or parts are unavailable it may be necessary to choose between them.

In such cases, the book value of service time might be misleading because of the impact of more unavailable vehicles (that is, downtime) on the bottom line. It might be preferable to get a vehicle back into service sooner and defer certain kinds of maintenance for a brief time.

When fleet objectives are not stated explicitly, it may be possible to deduce the fleet objectives from data-driven metrics of stress or waste. For example, a larger number of (found-during-visit) repairs, and (performed-during-driver-report pm) indicate an ‘aggressive’ shop maintenance policy.

On the other hand, a larger number of DRIVER REPORT service events, may indicate that maintenance has not been effective. Similarly, repeated shop visits for the same subsystem within a short period may indicate a lack of resources, or a lack of effectiveness.

It is possible that these indicate situations where there is an aggressive policy which could be refocused to both reduce downtime and also reduce the maintenance spend.

The availability of resources can lead to different results at the same level of alert accuracy. While this analysis refers to time saving, those skilled in the art will appreciate that a similar analysis can apply to financial cost.

Evaluating return on investment (ROI) using time means that time estimates for what happens in different scenarios are needed. Uncertainties about this can affect the outcome.

First, warning signs do not lead to breakdowns in a fixed time, so it is probabilistic information. For example, the probability of breakdown might be 1/100/week if no warnings have been received, and 2/10/week if a warning has been received. While this is a big difference, there will also be cases where there is a warning but nothing happens. Larger data samples (e.g., a greater number of vehicles) may help document the improvement in uptime benefits.

It is not known how long a vehicle might be down if there is a ‘false’ (or true) alarm. This can make it difficult to compute the net result of a policy.

For example, in a first scenario A, suppose a shop visit takes ten minutes to inspect a vehicle when nothing is wrong, but a whole day (24 hours) when something is actually wrong, and 1.5 days (36 hours) when there is an unplanned breakdown. Then it is much less expensive to check out every alarm than it is to deal with the effect of a missed problem. This scenario is illustrated in Table 1.

TABLE 1
Downtime costs of scenario A

| | | Time to check | Time to fix |
|---|---|---|---|
| Problem | Alert | (hours) | (hours) |
| no | no | 0 | na |
| no | yes | 0.166 | na |
| yes | no | na | 36 |
| yes | yes | na | 24 |

On the other hand, in a second scenario B, suppose a shop visit takes four hours when nothing is wrong, but a whole day (24 hours) when something is actually wrong, and one day and two hours (26 hours) when there is an unplanned breakdown. Then it is more expensive to check out every alarm than it is to deal with the effect of a missed problem compared to scenario A. This scenario is illustrated in Table 2.

TABLE 2
Downtime costs of scenario B

| | | Time to check | Time to fix |
|---|---|---|---|
| Problem | Alert | (hours) | (hours) |
| no | no | 0 | na |
| no | yes | 4 | na |
| yes | no | na | 26 |
| yes | yes | na | 24 |

Now suppose that, in a week, the alert occurs ten times in a week and has a 90 percent chance of being correct.

Then, in scenario A, it will be wrong once, costing ten min, and correct nine times, saving 9·(36−24)=108 hours.

In scenario B, it will be wrong once costing four hours and correct nine times, saving 9·(26−24)=18 hours.

This is a significant difference substantially independent from alert accuracy.

Table 3 illustrates a scenario where the alert is less accurate than 90 percent.

TABLE 3
Downtime saving for different accuracies (hours)

| | scenario A | scenario B |
|---|---|---|
| Accuracy | (hours) | (hours) |
| 0.2 | 10.7 | −28.0 |
| 0.5 | 59.16 | −10.0 |
| 0.75 | 89.53 | 5.0 |
| 0.9 | 107.83 | 14 |

So, in other words, the payback for accuracy is quite different in these two scenarios. In scenario A, even weak prediction (20 percent) produces a saving, while in scenario B, only a 75 percent plus accuracy can produce a saving. This why it is important to know how long vehicles will spend in the shop.

Accuracy values that meaningfully affect the probability of an event provide useful information. So if the baseline chance of failure is one percent, and a unit has a 20 percent chance of failure, this is substantial information. As another way to think of this, if the chance of a genetic disorder is 1/1000,000, and a diagnostic test tells us that a person has a 20 percent chance of having the disorder, then something has been learned.

It is understood that the term “accuracy” is to be construed broadly and generally denotes the probability there is an issue given that there is an alert, expressible symbolically as P (real issue|alert).

The other measure of accuracy is how many real issues get missed, β=P (no alert|real issue); that is, false negatives. The discussion above is focused on α=P (alert|no issue) (that is, false positives) as a problem to be avoided.

However, α is not restricted to a single value. For example, instead of sending an alert after a single trigger of a diagnostic trouble code (i.e., a fault code), three occurrences can be awaited. This kind of ‘bias’ can be a good thing. Since this increases the probability that there is a real issue, it reduces the value of α. At the same time, it might make it more likely that an alert would fail to appear when there is a real issue. That is, it increases the probability of a false negative. Depending on the cost of a false negative, this can be a desirable tradeoff.

In other words it is usually possible to trade off α and β to decrease a if that is more important. This is done by altering how conservative the system is when deciding whether to send an alert.

The best way to make this choice will depend on the costs and benefits of each of the four scenarios; that is, true positive (TP), false positive (FP), true negative (TN), and false negative (FN).

For these reasons it is quite important to know what the time savings actually are. If this is known, the appropriate α and β to aim for in setting up alert thresholds can be determined.

Vehicle service event forecasting may include determining a projected time to failure for a vehicle based on the vehicle telematics data for the vehicle. It may also include prediction of future failure modes in view of observed vehicle telematics data, and their consequences for future cost of ownership. By developing a model of when a failure event occurs, the model can be used to schedule service events (i.e., shop visits).

Some fault codes might occur often in different vehicles, or re-occur often in the same vehicle and rarely lead to breakdowns. The descriptions of these fault codes might be hard to understand, so the end user might not even know which vehicle system is involved, or what the potential financial costs of neglect might be. Such situations can result in unnecessary shop visits, and are a distraction for fleet operators.

Accordingly, leveraging information that can come from looking at cases where two or more fault codes occur together (cluster) can be beneficial. This analysis may add to the priority system by more accurately pinpointing significant issues. With a better idea of what is wrong, a manager could better decide which vehicle to send to the shop, and to be more comfortable when he or she decides not to send a vehicle to the shop.

### Vehicle Telemetric Data

Vehicle telemetric data can include fault code event data, wear data, use data, and other appropriate data. The vehicle telemetric data is used to predict future probabilities of failure of one or more components of the vehicle to keep it running,

### Example of Vehicle Telemetric Data-Fault Codes

Fault codes, also known as diagnostic trouble codes (DTCs) are generated by different electrical components of vehicles and can be reported back to a central service for analysis. Individual fault codes can give an indication of the condition of various components of the vehicle, particularly when considered collectively.

Because they are most common, emissions-related fault codes will now be discussed. There are two ways to look at this. The first way is to detect if a group of fault codes refers to the same part of the vehicle.

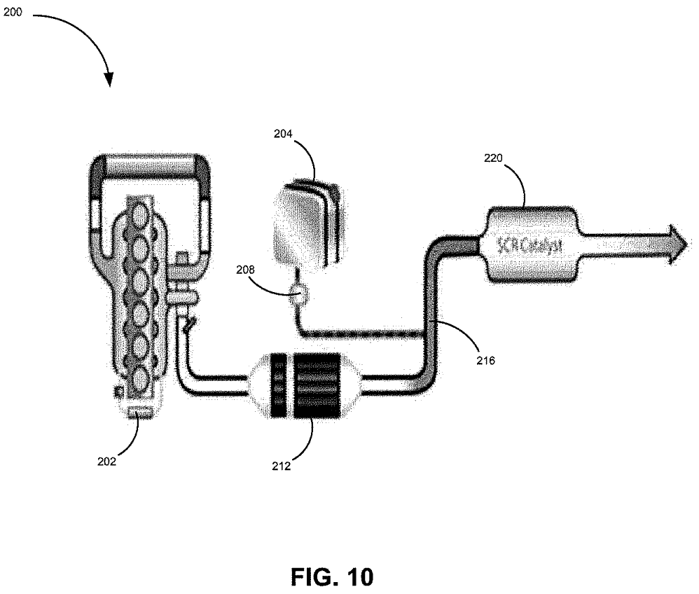

FIG. 10 shows various components of an emissions system 200, including a diesel engine 202, a DEF tank 204, a dosing control unit 208, a diesel particulate filter 212, a decomposition reactor 216, and an SCR catalyst 220.

By matching fault codes to physical components in the exhaust system 200, it will possible to flag situations when more than one fault code points to the same physical component. This presumably means that the issue(s) to be signaled are related to a single root cause involving that component.

A second way to look at fault code groups is to determine which fault codes have occurred in the same vehicle over a limited period of time, say six months to a year. The results of such an analysis might overlap with the location mapping method suggested above, or it might group together functionally related components. For example, components which are upstream or downstream from one another. In either case, a statistical association between fault codes can also point to a root cause, such as impurities in the DEF tank. See Table 4.

TABLE 4
Common exhaust FCS

| CODE | DESCRIPTION | GROUP |
|---|---|---|
| 1072 | Catalyst system efficiency below threshold bank 2 | A |
| 3556 | Aftertreatment 1 hydrocarbon doser 1 | A |
| P20EE | SCR NOx catalyst efficiency below threshold bank 1 | A |
| 3821 | Engine exhaust gas recirculation 1 valve 2 control | B |
| 2791 | Engine exhaust gas recirculation 1 valve 1 control 1 | B |
| 5835 | Aftertreatment 1 particulate sensor (mg/m3) | C |
| P24D1 | Particulate matter sensor regeneration incomplete | C |
| P24AF | Particulate matter sensor circuit range/performance | C |
| 8430 | SCR NOx catalyst efficiency below threshold bank 1 | D |
| P2698 | Exhaust aftertreatment fuel injector “A” performance | D |
| P05EB | Cold start SCR NOx catalyst inlet temperature too low | D |
| 2791 | Engine exhaust gas recirculation 1 valve 1 control | E |
| 3821 | Engine exhaust gas recirculation 1 valve 2 control | E |
| 3251 | Aftertreatment 1 diesel particulate filter differential | F |
| | pressure | |
| 3216 | Engine exhaust 1 NOx 1 | F |

A cluster analysis identifies separate groups of vehicles with a certain pattern of fault code occurrence. Since there are many potential fault codes that can occur, it is a high dimensional space, so if a vehicle is in one cluster and definitely excluded from another, it is good evidence of a different root cause.

When clusters are displayed, vehicles are labelled with 1-N according to which cluster they belong to. This is more useful for the analyst than the end user.

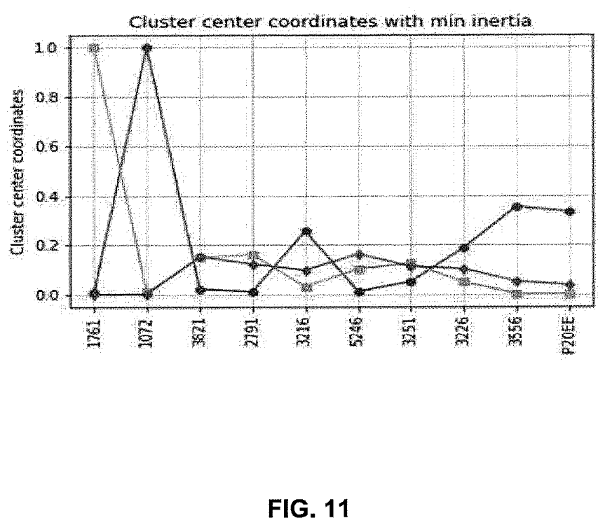

It is also possible to display a graph of the counts for the common fault codes in the cluster. See FIG. 11.

When there is a dominant fault code in a cluster and it is accompanied by others in a cluster, it would be possible to tell an end user that the vehicle has a common set of symptoms that point to a real cause. For example, the vehicle emissions system may be signaling a ‘stress pattern’ or ‘stress mode’ and that a ‘stress mode’ can lead eventually to a ‘failure mode’.

In terms of feature design, this can be reported separately from the individual fault codes.

FIG. 11 shows an example of cluster centers. The first two clusters have a dominant fault code (1761, 1072), which increases the likelihood of several other less dominant fault codes. If several fault codes from the cluster are present in the same vehicle including the dominant one, the probability that this is a real problem with an identifiable cause is increased.

### Battery Health

As batteries are a critical component for the functioning of a vehicle, modelling of battery health is also forecast via modelling equations. Thus, it is desirable to forecast their lifetime in order to determine a maintenance strategy that is aligned with the objectives of the organization.

A time series simulation method is used to determine the near-term probability of battery failure. The model has three time-dependent variables, v the battery voltage under charge, h the present battery charge (coulombs), and ρ the battery charge capacity in coulombs. While reserve capacity is typically measured in minutes and equals the amount of time a battery can deliver 25 amperes before the voltage falls below 10.5 volts, it is convenient to assign a variable which measures the actual charge available.

Voltage under charge is defined as mean voltage during a trip with the initial transient during start removed. It is expected that the charge will vary from day to day in a random manner but will be bounded above by the capacity. The capacity is expected to decline slowly over three to four years.

Of these variables, only the voltage v is observable, and the remaining variables are deduced from the time series:

$${v}_{n} = {v}_{0} + \frac{{h}_{n}}{( A + {ρ}_{n} )} K , \qquad ( 1 )$$

$${h}_{n + 1} = β {h}_{n} + {ϵ}_{n} , and \qquad ( 2 )$$

$${ρ}_{n + 1} = α {ρ}_{n} , \qquad ( 3 )$$

where hₙ<ρₙ, n is a time index, A is a base charge, a is a decay rate, β is a leakage rate, and ∈ₙ is a random error term which also cannot be directly observed. If the charging system is healthy, it is expected to have an upward bias, but some trips may have net negative effect. The constants v₀ and κ specify the voltage ceiling and scale factor.

Given the initial values of ρ, h and v and the error term series, ∈ₙ, n=0, 1, 2, . . . , the future values of ρ, h, and v are determined by these equations. This difference equation formulation assumes 1st order dynamics and behaves like a system of 1st order differential equations with random forcing.

Since h and ρ are not directly observable, one has to work backwards to estimate them. Since a series of v values can be observed, enough equations can be obtained to estimate ∈_{□} when ρ is known, and to estimate ρ when ∈_{□} is known. It is not possible to estimate both these quantities simultaneously from the series, since each time step introduces a new unknown quantity.

However, equation 1 for vₙ can be subtracted from vₙ₊₁ using equation 1, and, defining: D=(vₙ₊₁−vₙ)/κ, and B=κ/(vₙ−v0):

$$D = {h}_{n} ( \frac{β}{A + α {ρ}_{n}} - \frac{1}{A + {ρ}_{n}} ) + \frac{ε}{A + α {ρ}_{n}} , \qquad ( 4 )$$

and since

$${h}_{n} = \frac{( A + {ρ}_{n} ) ( {v}_{n} - {v}_{0} )}{k} , \qquad ( See Eq . 1 )$$

it is possible to substitute for hₙ in the equation for D obtaining:

$$BD - ( \frac{A ( β - 1 ) + {ρ}_{n} ( β - α )}{A + {αρ}_{n}} ) \qquad ( 5 )$$

$$= ϵ B / ( A + {αρ}_{n} ) \qquad ( 6 )$$

so that:

$$ϵ = \{ ( A + αρ n ) BD - ( A ( β - 1 ) + {ρ}_{n} ( β - α ) ) \} / B \qquad ( 7 )$$

∈ can be estimated from vₙ, and vₙ₊₁, and ρ.

Defining R(∈)=B_{∈}E+A(β−1) and using similar reasoning gives the corresponding solution:

$$B D = \frac{R ( ϵ ) + ( β - α ) {ρ}_{n}}{a + α {ρ}_{n}} , \qquad ( 8 )$$

$${ρ}_{n} = \frac{B D A - R ( ϵ )}{( β - α ) - α BD} \qquad ( 9 )$$

when ∈ is known.

Many of these estimates are sensitive to differences between small numbers, however the estimates of ∈ₙ are not very sensitive to the value of ρ. This means that it is possible to get estimates for the entire series of ∈ up to the present after making an educated guess at ρ. This series can then be re-sampled randomly to simulate the forward progress of the battery voltage.

While classical estimates exist for the maximum and minimum of a randomly driven series, the use of simulation accounts for the moving boundary of the reserve capacity, and replicates the in-situ parameters of driving style and charging system health. Because the model equations are relatively simple it is feasible to run hundreds of simulations rapidly to get a probability distribution.

The data series is interpolated so that the simulation can produce a timeseries which simulates a fixed number of starts/day.

Nominal parameters are set as follows:

TABLE 5
Basic parameters

| param name | value | explanation |
|---|---|---|
| npointslimit | 100 | max recent trips |
| base V0 | 11.5 | v₀ |
| base V init | 14.8 | initial v |
| A base charge | 900000.0 | A |
| rho reserve charge | 150000.0 | default assumed reserve charge |
| failure fraction | 0.2 | charge fraction at failure |
| starts per week | 21 | assumed starts/week |
| beta leak3 | 0.999 | leak fraction between starts |
| years to decay | 3 | battery decay time const |
| danger fraction | 0.3 | charge fraction in decay calc |
| default charge level | 0.8 | assumed charge with no data |
| nsims | 250 | simulations per start point |
| nsteps | 900 | run sim nsteps days |
| seedlen | 5 | number sim start points |

TABLE 6
Derived parameters

| param name | value | explanation |
|---|---|---|
| failure threshold | rho reserve charge * failure fraction | |
| starts per day | starts per week/7 | |
| beta leak | beta leak3 ** (starts per day) | β |
| | hours between starts 24/starts per day | |
| secs between starts | hours between starts * 60 * 60 | |
| sample interval | starts per day * secs between starts | |
| kappa | (base V init − base V0) | |
| | * (A base charge + rho reserve charge)/rho reserve charge | κ |
| | alpha decay inv time (1.0/(years to decay * 52.0)) | |
| alpha decay3 | exp(log(danger fraction) * alpha decay inv | |
| | time/starts per week) | |
| alpha decay | alpha decay3 ** (starts per day) | α |
| rho0 | rho reserve charge * default charge level | |

It will be appreciated that these methods are exemplary. Other methods applied to other systems of the vehicle might also be applied without departing from the spirit of the invention.

### Service Events

Detailed service records for 483 vehicles during a three-month period have been studied. These records show service events classified by ACTION and JOBTYPE and also have VMRS codes and descriptions. ACTIONS include TOW, REPAIR, INSPECT etc, but JOBTYPE is more complex, including ACCIDENT, OPERATOR REQUEST, FOUND DURING DIAGNOSIS, PM etc. This has implications for aggregation of cost and predictive functions for service events which belong to different categories. The following is a list of service event details:
common job types=[′PREVENTIVE MAINTENANCE′, ‘SEND TO VENDOR’, ‘ROAD CALL’, ‘CAMPAIGN RECALL’, ‘ACCIDENT’, ‘DEPT REQUEST’, ‘FOUND DURING PM’, ‘FOUND DURING DIAGNOSIS’, ‘NORMAL WEAR’, ‘OPERATOR REPORT’, ‘COME BACK’, ‘DAM-AGE’, ‘TEST SUITE FAILURE’]
common actions=[′EXCHANGE NEW′, ‘TOW’, ‘JUMP START’, ‘NEW INSTALL’, ‘STRIP OUT’, ‘PM INSPECT’, ‘ADD FLUIDS’, ‘DIAGNOSIS’, ‘FABRICATION’, ‘ROAD CALL’, ‘CLEAN’, ‘SERVICE’, ‘ADJUST’, ‘REPAIR’, ‘INSPECT’]

TABLE 7
Most common service event classifications

| JOBTYPE | ACTION | Number |
|---|---|---|
| FOUND DURING PM | EXCHANGE NEW | 193 |
| FOUND DURING DIAGNOSIS | EXCHANGE NEW | 92 |
| NORMAL WEAR | EXCHANGE NEW | 9 |
| OPERATOR REPORT | EXCHANGE NEW | 355 |
| ROAD CALL | TOW | 60 |
| PREVENTIVE MAINTENANCE | INSPECT | 578 |
| OPERATOR REPORT | ADD FLUIDS | 27 |
| FOUND DURING PM | DIAGNOSIS | 32 |
| OPERATOR REPORT | DIAGNOSIS | 118 |
| ROAD CALL | ROAD CALL | 27 |
| OPERATOR REQUEST | ROAD CALL | 44 |
| DEPT REQUEST | CLEAN | 28 |
| CAMPAIGN RECALL | SERVICE | 37 |
| OPERATOR REPORT | ADJUST | 27 |
| FOUND DURING PM | REPAIR | 45 |
| FOUND DURING DIAGNOSIS | REPAIR | 55 |
| OPERATOR REPORT | REPAIR | 517 |
| PREVENTIVE MAINTENANCE | INSPECT | 1569 |
| DEPT REQUEST | INSPECT | 28 |
| OPERATOR REPORT | INSPECT | 23 |

As noted, each fleet/organization may be expected to have different policy objectives and different levels of effectiveness in implementing them. For example, objectives might be:
(1) primarily to minimize downtime and maximize safety, or
(2) primarily to make the best use of limited shop resources, or
(3) primarily to limit annual costs.

Alternatively, it might be a combination of (1)-(3). These objectives could compete with one another. So there could a great deal of variation in maintenance patterns.

The methods provided in this disclosure may be adapted depending on the mix of objectives for the fleet, and current practices and resources.

In reviewing the data summarized in Table 7, events were classified as planned and unplanned, how much they cost and whether they were predictable from a telematics sign such as a fault code in the few days before the service event.

Three types of event classification were considered. The first was a preventative maintenance (PM) service visit, which could be scheduled in advance. The second was a TOW or ROAD CALL, which would be completely unplanned (CU), perhaps with a vehicle being undrivable. The third category would be unplanned, but with the ability to make an appointment and drive the vehicle to a service facility. This is referred to as discretionary unplanned (DU) or reported. Most services with jobtype OPERATOR REPORT were assumed to fall in this category.

In general, the methods disclosed herein contribute to moving a service from the TOW or ROAD CALL to the PM or DU category.

A second benefit of this analysis is to help with a cost/benefit analysis of current maintenance workflows to see whether fleet maintenance objectives (see 1-3) are being achieved in a balanced way.

Unless otherwise stated, ACCIDENTS were excluded from this analysis.

A second metric was related to shop visit efficiency. This was reflected in cases such as ‘FOUND DURING PM’ or ‘FOUND DURING DIAGNOSIS’, or the fact that when a vehicle experiences a TOW or ROAD CALL, other services might be performed during the resulting shop visit for that day.

The prevalence of these cases may mean that the shop has a policy to catch as many problems as possible while the vehicle is in the shop, in order to prevent future shop visits and associated downtime.

To define visits, all service events for one date and one vehicle were considered.

To compute costs, the sum of job totals for service events for which the visit contained the Condition strings of Table 7 was computed. For example, if a visit had a TOW service event, then all costs associated with those within-visit events were summed.

TABLE 8
Number of visits and costs

| | | Total | N | Per visit |
|---|---|---|---|---|
| Classification | Condition | cost | visits | cost |
| Unplanned (CU) | TOW, ROAD CALL, | 162984.89 | 152 | 1072.27 |
| | ACCIDENT | | | |
| Unplanned (CU + | TOW, ROAD CALL, | 985049.02 | 941 | 1046.81 |
| DU) | OPERATOR REPORT | | | |
| Everything else | not CU, DU, not | 488938.04 | 701 | 697.49 |
| | ACCIDENT | | | |

TABLE 9
Number of vehicles and costs (3 months)

| | | | | Per |
|---|---|---|---|---|
| | | Total | No. | vehicle |
| Classification | Condition | cost | vehicles | cost |
| Unplanned (CU) | TOW, ROAD CALL, | 162984.89 | 95 | 1715.63 |
| | ACCIDENT | | | |
| Unplanned (CU + | TOW, ROAD CALL, | 985049.02 | 304 | 1046.81 |
| DU) | OPERATOR REPORT | | | |
| Everything else | not CU, DU, not | 488938.04 | 380 | 697.49 |
| | ACCIDENT | | | |

### Smart Preventative Maintenance and Consolidation of Service Visits

As may be seen from Tables 8 and 9, the impact of TOW and ROAD CALL service events is significant, but only about 152/(152+941+701)=8.5 percent of visits and 162984/(162984+985049+488938)=10 percent of costs.

However, the combination of CU and DU service visits are 941/(152+941+701)=52 percent of visits and 985049/(162984+985049+488938)=60 percent of costs documented in service records.

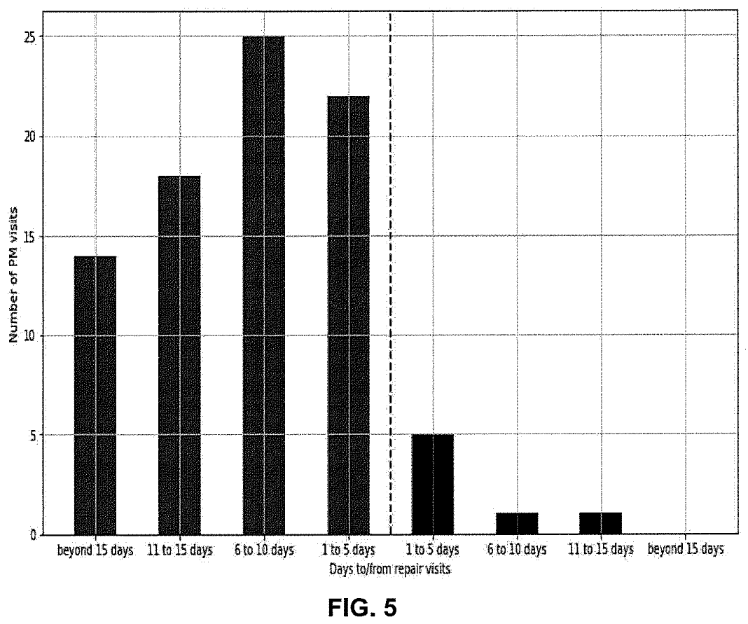

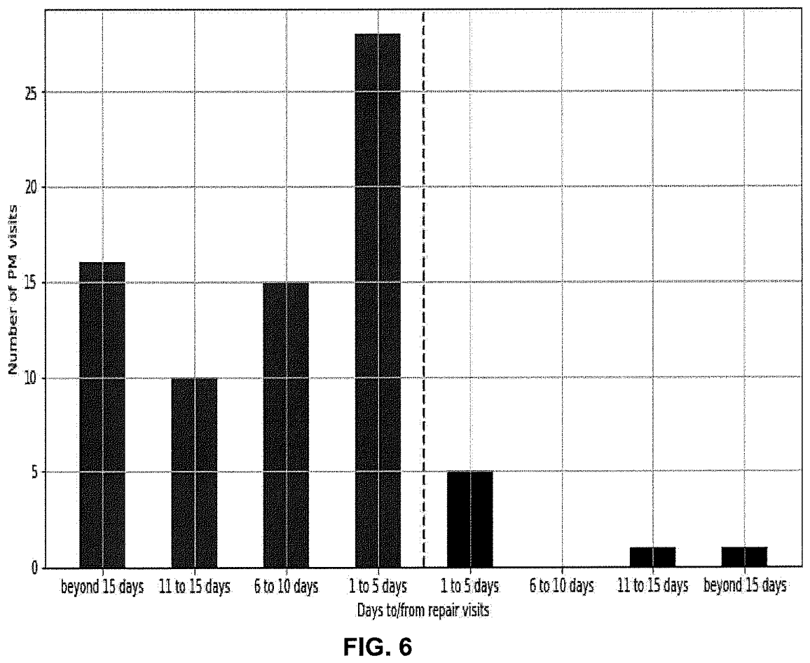

FIGS. 5 and 6 show the timing of non-REPAIR/REPLACE visits, versus REPAIR/REPLACE visits. The non-REPAIR/REPLACE visits can be thought of as planned visits, these are aligned in time (center line) with REPAIR/REPLACE visits which can be thought of as unplanned.

In particular, FIG. 5 shows shop visits for CNG vehicles: timing of non-repair vs repair visits. The vertical dotted line represents repair/replace shop-visits that are collapsed together on a single line. The bars to the left of the dotted line show the number of PM visits before repair-visits within different ranges of days (e.g., within 1 to 5 days, 6 to 10 days, 11 to 15 days). It was observed that there were 22 cases (the first red bar from the left of the dotted line) that a repair-visit occurred after a PM-visit within 5 days. Similarly, the bars on the right of the dotted line indicate the number of PM-visits after a repair-visit.

FIG. 6 shows shop visits for gas vehicles: timing of non-repair vs repair visits. This graph is similar to that shown in FIG. 5. The vertical dotted line represents repair/replace shop-visits that are collapsed together on a single line. The bars to the left of the dotted line show the number of PM visits before repair-visits within different ranges of days (e.g., within 1 to 5 days, 6 to 10 days, 11 to 15 days). The bars on the right of the dotted line indicate the number of PM-visits after a repair-visit.

Shop visits which are close together in time can potentially be consolidated. If predictions are available for the unplanned visits, then those service could be moved back in time and consolidated with the planned visits.

A second case (not shown) aligns on PM visits. PM visits would normally be prescheduled, whereas unplanned REPAIR visit might occur at random times. If a PM visit is due soon, however, it could be consolidated with the upcoming PM.

In fact, examination of the sample service records suggested that there is already a considerable amount of consolidation within service visits. See Table 7.

### Fault Code Timing Versus Service Events

Vehicle telematics data can give more insight into these cases, either through earlier advance warning, or reducing reliance on OPERATOR REPORTs to detect cases. For this reason, the timing of fault codes compared to the timing of CU and DU service visits was investigated.

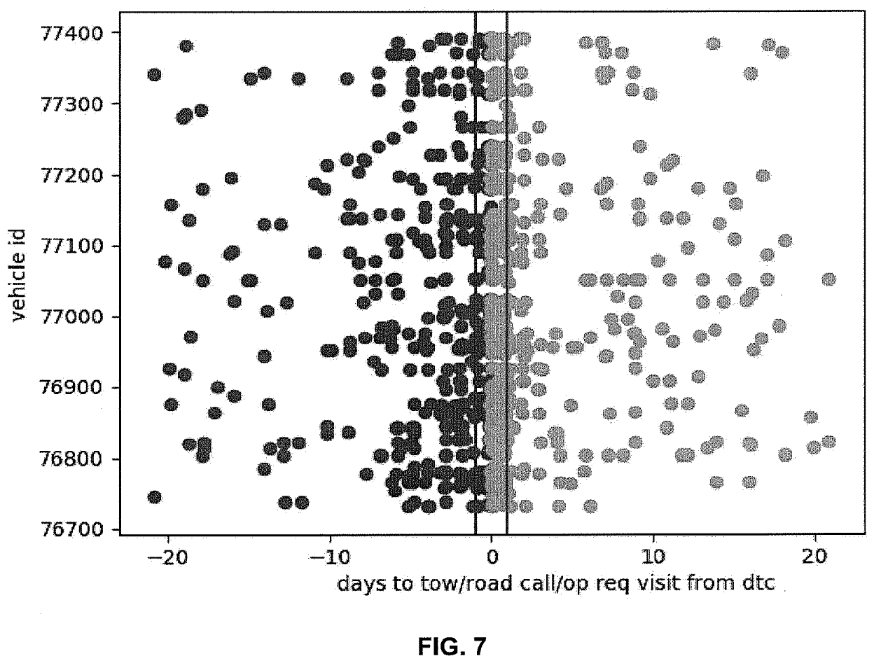

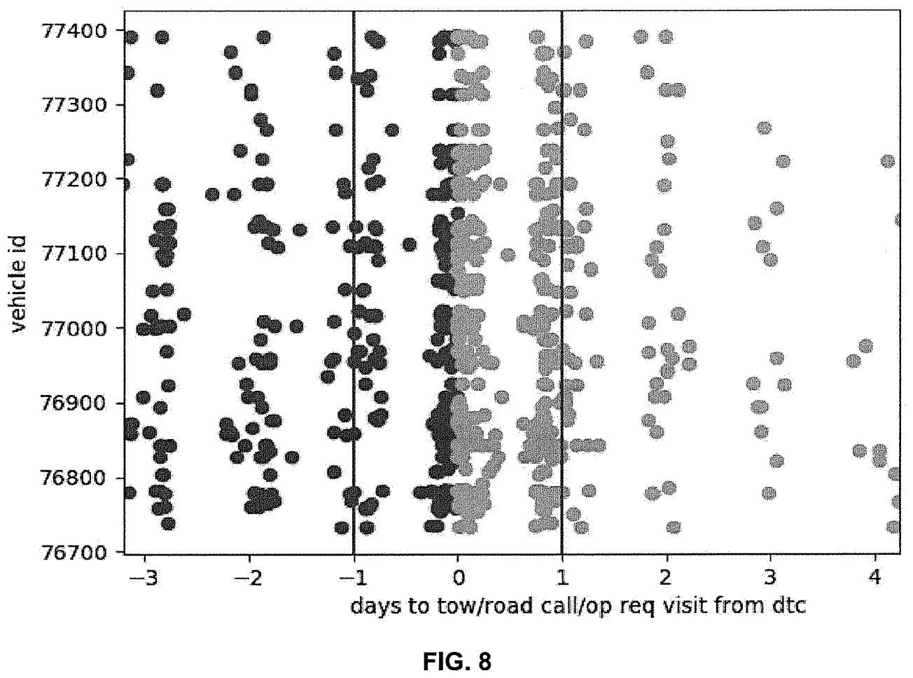

FIGS. 7 and 8 show the relative timing in days between the last fault code (DTC) trigger before a CU+DU service event and the service event. It appears that there is an increased probability of seeing a fault code in the 1-5 days before the service event. If so, this would suggest that such service events might be predictable from telematics.

In particular, FIG. 7 shows fault code timings before and after an unplanned service event (CU+DU). The vertical axis is a vehicle identifier (ID) while the horizontal axis is in days. Vertical lines indicate+−1 one day on either side of midnight on the day of the service event. Dots to the left of zero are the last fault code times before the event, while dots to the right of zero are the first fault code times after the service event. It may be seen that the density of blue dots increases immediately before the service event, especially in the day immediately before. There is also a band of red dots on the day of service between the vertical lines. These may not be as useful for prediction, but there is not enough time resolution in the service date to be conclusive.

FIG. 8 shows the fault code timings before and after an unplanned service event (CU+DU). This blows up the scale near 0 days. The double band of red dots between 0 and 1 is likely because vehicles were parked overnight on the day of service which is the time interval (0,1).

Now, the justification for a data driven prediction of unplanned visits is discussed.

If operators noticed something wrong they might have brought the vehicle to the shop without any knowledge of the fault code. Alternatively however, the fault code was triggering because of a related problem and could have served as an effective warning of these problems.

Therefore the techniques disclosed here could have predicted the problem beforehand without relying on the operator.

However also considered were some alternative explanations for the observation that fault codes seem more frequent before a CU+DU service event, where the events include a large proportion of OPERATOR REPORTS.
(1) Did operators bring in the vehicles because the engine light was on? ENGINE LIGHT DIAGNOSIS is only rarely mentioned in the services records and there seemed to be many fault codes that did not lead to a service event, so codes did not invariably predict service events. Accordingly, a weak association may exist with the engine light.
(2) Did the difference in fault code density before and after service events happen because the shop routinely clears all codes? This would create a lower code density after a shop visit which return over time to the normal code density if the actual problem had not been fixed. (i) It is possible this mechanism played some role, but this is not mentioned in service records (ii) it does not explain the density increase prior to the service event.
(3) If fault codes are frequent for certain vehicles, then the last in a series might be closer to any random time, for example 12 noon. Does the increase in density only mean that some vehicles had constantly triggering codes because they were chronically unhealthy? In other words, maybe there was nothing special about the service event time. If so, an individual fault code trigger would not really predict failure at a specific time. Repeating codes do happen, but if so, it is a bit harder to explain why outside of the +−5 day windows, incidence rates for fault codes are quite similar before and after the service event.

As a next step, codes were counted, and costs were computed within the +−1 and +−5 day windows near the service events.

Table 10 shows that there were 347 codes seen in the 1 day before the CU+DU service events compared to 61 seen on day 1-2 (a one day interval). The costs were respectively $415129 and $67058, which is a ratio of about 6:1. Mean cost per event stays around $1200, except for the vehicles that never showed any codes, for which it is about half. The first conclusion is that there is not much difference in costs or code counts when comparing a 21 day window before, with a 21 day window after the service event. Relationships between code frequency and the service event show up in the +−5 day and +−1 day windows.

TABLE 10
Costs vs code counts near a service event

| | Code | | per event |
|---|---|---|---|
| Window | Count | events cost | cost |
| 21 days before | 651 | 782816.39 | 1202.48 |
| 21 days after | 668 | 802123.60 | 1200.78 |
| 5 days before | 532 | 652407.36 | 1226.32 |
| 5 days after (1-6) | 105 | 119084.38 | 1134.13 |
| 1 day before | 347 | 415129.61 | 1196.33 |
| 1 day after (1-2) | 61 | 67058.07 | 1099.31 |
| no code | 223 | 128983.89 | 578.40 |

Now, the probability of a code, given that there is a service event, is discussed. However, in practice it is desired to know how likely a service event is, if a certain code is seen. In theory this can be computed using Bayes rule.

However, unfortunately a good estimate of P (B=probability of dtc/vehicle, day) is not available. This is because some vehicles have repeated fault codes at different rates and many vehicles 223/941=0.237 have none at all even within the TOW/ROAD CALL/OPERATOR REPORT CATEGORY. In addition, many service events might need to be excluded because they would never be associated with fault codes.

This study found that a fraction (941−532)/941=0.435 or 43.5 percent had no fault codes in the preceding 5 days.

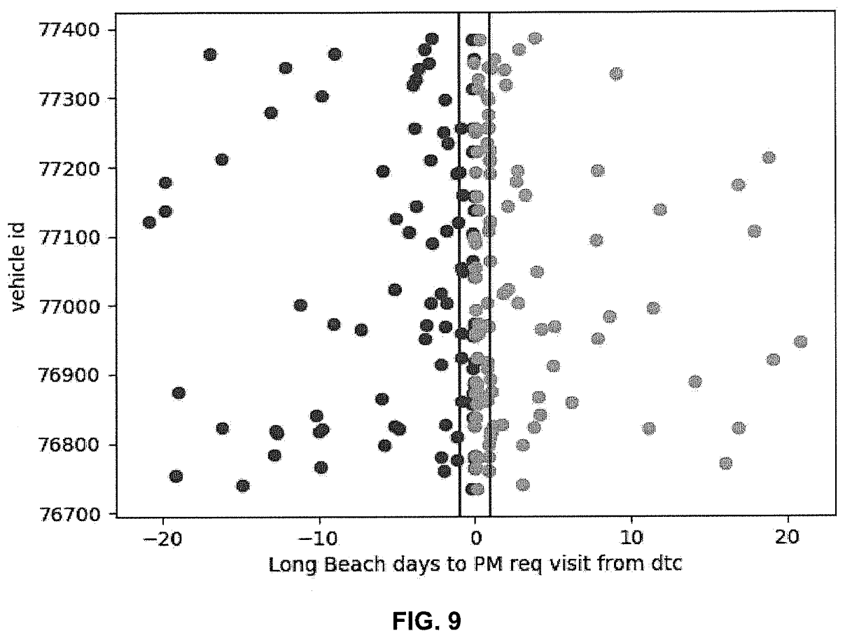

A simpler way to assess the predictive value of fault codes was to compare incidence on a healthy comparison group. To supplement the study of fault code timing, a graph of fault code timings compared to a PM/PREVENTIVE MAINTENANCE service events was constructed. Results are shown in FIG. 9 and Table 11 (comparison can be made to FIG. 7 and Table 10). There were 301/1654 such visits.

FIG. 9 shows fault code timings before and after an PM/PREVENTIVE MAINTENANCE event. Maintenance events arising from a TOW/ROAD CALL/OPERATOR REPORT were excluded. The vertical axis is a vehicle id while the horizontal axis is in days. Vertical lines indicate+−1 one day on either side of midnight on the day of the service event. Dots to the left of zero are the last fault code times before the event, while dots to the right of zero are the first fault code times after the service event.

TABLE 11
Costs vs code counts near a PM event

| Window | Code count | events cost | per event |
|---|---|---|---|
| 21 days before | 99 | 85939.02 | 868.07 |
| 21 days after | 104 | 88694.08 | 852.82 |
| 5 days before | 70 | 66815.05 | 954.501 |
| 5 days after (1-6) | 27 | 23789.10 | 881.07 |
| 1 day before | 40 | 36613.68 | 915.34 |
| 1 day after (1-2) | 9 | 12020.25 | 1335.58 |
| no code | 181 | 97103.68 | 536.48 |

Visits containing PM/PREVENTIVE MAINTENANCE which arose from a TOW/ROAD CALL/OPERATOR REPORT were excluded from this count. As may be seen from FIG. 9, it also shows some tendency for fault codes to cluster before the PM/PREVENTIVE MAINTENANCE event.

There were 40 visits with last code one day before compared to 9 visits with first codes during day 1-2 post service. There were 70 visits with last code five (5) or fewer days before compared to 27 visits with first codes during day 1-6 post service. One day ratio was 70/27=2.6 versus 347/61=5.7 for TOW/ROAD CALL/OPERATOR REPORT events. For those vehicles (301−70)/301=0.767 fraction or 76.7 percent had no codes in the preceding 5 days.

This might be interpreted as evidence against the predictive value of the fault code timing, since fault code clustering was previously taken as predicting unplanned services. However, also observed was that the number of fault-code-free visits (before or after) was 223/941=23.7 percent for TOW/ROAD CALL/OPERATOR REPORT, compared to 181/301=60 percent of visits for PM/PREVENTIVE MAINTENANCE. This indicates that candidates for PM had 3 times fewer fault codes per visit than candidates for TOW/ROAD CALL/OPERATOR REPORT.

Mean costs were somewhat lower (25 percent) (compared to Table 10 and Table 11) and also because of smaller numbers (301 vs 941), total costs associated with the PM events were a factor of 5 ($196952 vs $985049) less than those associated with TOW/ROAD CALL/OPERATOR REPORT. While some fault code density enhancement did occur prior to the PM, this would be expected from the hypothesis that vehicles which have problem might emit fault codes repeatedly.

Thus, a reasonable interpretation of these data, taken together is that vehicles which have problems have more frequently triggering fault codes, and are also more likely to be reported by drivers (or towed). In addition, vehicles without fault codes require less expensive repairs/maintenance on the average.

### Savings Mechanisms

The simplest savings mechanism is to predict a failure that would have resulted in a TOW or ROAD CALL and convert it into a discretionary unplanned (DU) event. There were a total of 147 TOW or ROAD CALL events in the 3 month period, with a total cost of 61201.32 (for TOW or ROAD CALL, excluding repair). If a fraction c of these events is predicted, the savings would be, c×147×416.33 where 416.33 is the average cost of a TOW or ROAD CALL.

A second important mechanism with some fleets is consolidation of shop visits. In this mechanism, PM procedures can be moved to coincide with repairs, or predicted future repairs are performed in the current PM. It appears that limited savings are available for the sample from this mechanism, since it is already being used in many cases.

A third mechanism is to triage OPERATOR REPORTS which form a large tranche of service cost for Long Beach. The data suggest that vehicles without recent fault codes are healthier than vehicles with codes, and require less expensive services. Therefore, it would be reasonable to delay services for OPERATOR REPORT cases when no fault code is present. This would apply to 223/941=23.7 percent of cases.

941 TOW/ROAD CALL/OPERATOR REPORT cases with a total cost of 985049.02 were observed. This is an average cost of $1046.81 per visit. Suppose that one declines to perform extra services on 23 percent of these visits in a three-month time period. This would amount to a maximum savings of $233436.91 over the three-month period or $77812.30/month of savings.

To be clear, any declined services would still have to be performed, but they would be moved to PM visits and spread out over a longer period. The savings would come from reducing the burn rate.

Consider a fleet of 1000 vehicles that are maintained once a month and require one simple maintenance task which costs 100 dollars each time. If they are maintained correctly, the risk of breakdown is tiny.

Normally, all the vehicles would receive the maintenance each month, so you would spend 100,000 dollars a month. This is the safest most conservative policy.

Now suppose a test can be done to determine if it is safe to skip the maintenance for one month. The test is performed, and it is determined that 25 percent of the vehicles each month pass the test. If the test is trusted, then the maintenance can be done on only 75 percent of the vehicles each month and 75,000 dollars a month can be spent.

In effect, the test allows one to stretch out the average time between maintenance tasks without significant increase in risk.

Another way to look at this is if monthly maintenance budget is reduced from 100,000 to 75,000 dollars/month, this does not have to impact safety or availability provided there is a good way to predict the maintenance status of the vehicle in the near term.

However, further complicating factors may be present.

For example, there might be several maintenance tasks which have different tradeoffs between safety and frequency. For reasons of convenience you would like to take care of all the maintenance tasks in the same PM visit. This likely means the above problem is multiplied by several tasks, because the consolidated PM frequency will most likely be determined by the task which needs to be done most frequently. The remaining tasks may end up being performed more often than necessary.

A second problem is that the main imperative may be to keep vehicles available and on the road. In this case, the conservative policy is to fix all problems found or suspected whenever the vehicle is in the shop. This is a simpler approach than attempting to solve the scheduling problem for all required maintenance tasks.

Alternatively, if there is a fixed monthly maintenance budget, it might be necessary to park certain vehicles with problems until the next maintenance period. Whether this is acceptable or not depends on the business requirements for the fleet.

Therefore if there are many operator reports of problems and the vehicle comes to the shop more often than really necessary it can be somewhat complex to decide which tasks need to be done immediately, and which can be postponed without much risk or downside.

Brake jobs, in cases where the brakes and/or sensors are not actually damaged are an example of this. Brake jobs are expensive, and require significant downtime, but they usually can be postponed for a period of time. For these reasons, postponing a brake job during an operator report visit, will usually not entail much risk but will reduce the monthly maintenance spend.

In other cases, such as damage to peripheral equipment, it could be justified to park the vehicle for a period of time unless this seriously conflicts with business requirements. Reducing the maintenance spend (burn rate) improves saving, unless it is penalized by other business requirements.

Thus, expensive operator request visit-associated tasks, where there are no fault codes, and reduced risk and business penalties should be considered as candidates for postponement.

The data suggest that moving declined services to PM visits could be accomplished with relatively small risk because it triages healthy vehicles; i.e., the ones with no fault codes.

Analysis of 223 visits for TOW/ROAD CALL/OPERATOR REPORT, where the vehicle did not have a fault code in the previous three weeks showed the following possible deferrable jobs on a total spend of $202232.

TABLE 12
Possible deferred maintenance categories (no dtcs)

| Category | Spend | Jobs | Unique visits |
|---|---|---|---|
| Brakes | 10964 | 48 | 44 |
| Cab and sheet | 16065 | 41 | 41 |
| metal | | | |
| HVAC | 1862 | 6 | 5 |
| Tires | 45164 | 235 | 187 |
| TOTAL | 74056 | | |

By reducing the number of unique visits by 50 percent, the associated burn rate becomes (74056/2)=37028 each quarter. This might be done by spacing out jobs into existing PM slots, or making some additional future appointments. The inclusion of tires as a deferrable category might lead to an over estimate, however it is unlikely that all tire events were flat tires.

In the above case, these maintenance categories are de-prioritized because the vehicles are likely to be healthy. Therefore, there is more value in keeping them available for use rather than keeping them in the shop for deferable maintenance.

However, a complementary case can be made that if the vehicles are undergoing work in response to CU and DU unplanned problems, the shop should prioritize those serious problems rather than spend additional time on deferable maintenance. This should help to create slack capacity in the shop which can improve turnaround time for more serious problems. It can also save costs via the burn rate triage (BRT) mechanism.

Analysis of 347 visits for TOW/ROAD CALL/OPERATOR REPORT, where the vehicle had a fault code in the previous 1 day showed the following possible deferrable jobs on a total spend of $415129.61

TABLE 13
Possible deferred maintenance (fault code 1 day before)

| Category | Spend | Jobs | Unique visits |
|---|---|---|---|
| Brakes | 24628 | 31 | 26 |
| Cab and sheet | 22841 | 61 | 53 |
| metal | | | |
| HVAC | 4581 | 9 | 9 |
| Tires | 48786 | 165 | 131 |
| TOTAL | | 100838 | |

By reducing the number of unique visits by 50 percent, the associated burn rate becomes (100838/2)=50418 each quarter. This might be done by spacing out jobs into existing PM slots, or making some additional future appointments.

The combination of the above would save $50418+$37028=$87446/quarter.

This strategy can take simple forms but it can also be complicated to apply when there are a mix of maintenance tasks, each with its own risk functions (i.e., risks you take when it is delayed) and unit cost.

### Presentation

While many parts of the present invention can be automated, implementation of a maintenance program requires the participation of human users including drivers, managers and technicians.

A software platform can assist with this in a number of ways.

A first feature is to maintain persistent histories of diagnostic signs by vehicle over time. It may also maintain histories of PM service and repairs. These histories may be searchable and it may be possible to add tags and notes for future reference.

A second function is to allow sharing of information across an organization by facilitating transmission of reports through printouts and emails.

It may also provide timely warnings when the consequence of inaction could be serious.

To help implement recommendations, it may provide convenient scheduling functionality, lists which can be ranked by different attributes including fault code and algorithmically generated priorities, and may provide recommended actions including the recommendation to check the vehicle immediately, or conversely do nothing. Scheduling functionality may be consistent with the objective to minimize the number and maximize the efficiency of service visits.

As is evident to those skilled in the art, these capabilities are straightforward to implement in modern software platforms which present persistent data stored in databases, such as Postgres. They can be implemented within a point and click interface in a manner similar to well known task managers and CRMs.

While straightforward, it is important to stipulate that managing a large fleet of 100+vehicles using the methods described in this disclosure would be difficult or impossible without a software interface, due to the need to monitor time series and quickly perform calculations.

### Brake Wear Analysis

Brakes play a fundamental role in how a vehicle operates. Along with tires, brake maintenance is a key to ensure proper functioning of a vehicle. An additional point is that brakes are not subject to the petrol/diesel divide that must be considered when building engine models-every vehicle has them. So having a model that takes brake wear into account and suggests replacements is useful.

The key difficulty with building a brake model is the fact that no single OBD-II PID is associated with the brakes. This is contrasting to something like the battery model in which case PID 2142 is a direct measure of the battery voltage. This difficulty means that indirect methods must be used to determine brake usage.

In short, brakes have no OBD-II PID associated with them, necessitating a cleverer approach to the problem of building a brake model.

The model described here is a practical way of tracking brake wear within a cohort of similar vehicles. The overall goal is to point out vehicles with higher than normal brake wear to the user (expected to be a fleet manager).

In short, this is done by:
detecting when braking events occur;
calculating a metric of brake usage per vehicle-energy dissipation per unit distance driven (called the dissipation value);
creating a frequency distribution of the above metric;
creating a distribution of brake services as a function of mileage driven; and
mapping between the distributions to get an estimated mileage for brake replacement given the dissipation value.

The above steps are explained in detail below.

The first step in the brake model is to determine when the brakes are being used. This could in theory be done easily if a custom brake PID (activation or pressure) is available—as seen in Geotab data sheets. Since this PID availability is not reliable, a more reliable solution is to use the speed PID (210D) to determine the acceleration and thus braking events.

From basic physics, the speed v can be differentiated to get the acceleration a:

$$a = \frac{d v}{d t} \qquad ( 10 )$$

Once we get the acceleration, this can be split into “windows” which are between 2 and 5 seconds long. In each such window, the fraction of points below a set acceleration threshold value (in ms2) is calculated. If this fraction is greater than a set amount (in percentage), then the entire window is marked as a brake event.

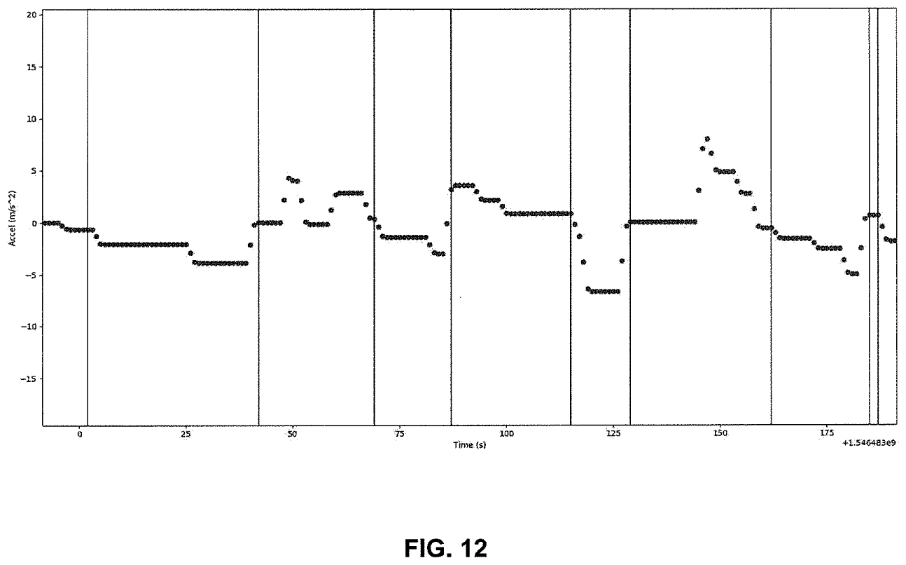

FIG. 12 shows a graph of acceleration (derived from speed) vs time showing brake events (brake events start at the green line and end at the red line).

Each window marked as containing a braking event, is then used in the dissipation value calculation stated in the next section.

Braking, by definition, slows down the vehicle. This means that looking at the speed PID (210D) could work in helping to figure out a metric of brake usage.

When a vehicle hits the brakes, the pads (or shoes in the case of drum brakes) are hydraulically actuated and make contact with the spinning rotor (or drum in the case of drum brakes). The rotational energy in the rotor is converted into thermal energy and the friction causes the pads to wear.

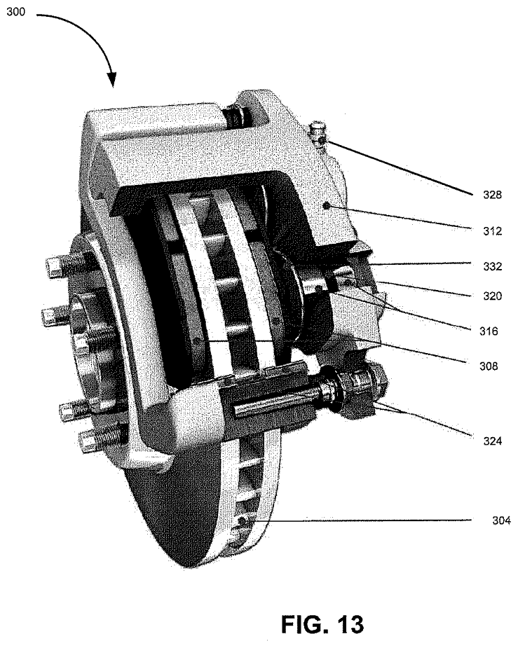

FIG. 13 shows a diagram of a brake assembly 300. The brake assembly includes a rotor 304, brake pads 308, a brake caliper 312, a piston 316, a piston seal 320, anti-rattle clips 324, a bleeder screw 328, and a dust boot 332.

The greater the usage of the brakes, the greater the energy dissipation 1115 and pad wear.

In other words, if one can calculate the energy dissipation during each braking event a vehicle undergoes, a metric of brake usage and hence brake pad wear can be determined.

From basic physics, it is known that the kinetic energy of a moving vehicle is given by:

$$K E = \frac{1}{2} m {v}^{2} , \qquad ( 11 )$$

where m is the mass and v is the velocity of the vehicle.

The rate of change of kinetic energy of a vehicle is:

$$\frac{d K E}{d t} = \frac{1}{2} \frac{{d ( m v )}^{2}}{d t} = m a v , \qquad ( 12 )$$

where a is the acceleration (dv/dt) of the vehicle.

This means that over the course of a braking event that starts at time tᵢ and ends at time t_{f}, the energy dissipated is:

$$Dissipation = {\int }_{{t}_{i}}^{{t}_{f}} \frac{d K E}{d t} d t = {\int }_{{t}_{i}}^{{t}_{f}} mavdt , \qquad ( 13 )$$

The dissipation in Eq. 13 above depends on the length of the trip—the longer the trip, the higher the likely brake usage and the higher the dissipation. So in order to account for this, one divides by the trip mileage to get the dissipation value:

$$DissipationValue = \frac{Dissipation}{Tripmileage} = \frac{{\int }_{{t}_{i}}^{{t}_{f}} m a v d t}{Tripmileage} . \qquad ( 14 )$$

The dissipation value is in units of Joules/km.

This indicates that if one can obtain the speed of the vehicle and the trip mileage, the dissipation value can be calculated. The speed v can be differentiated to get the acceleration a.

The mass m can effectively be ignored as the dissipation value is a measure of brake usage in a cohort of vehicles (i.e., a group of vehicles that are similar in specifications and/or operation). In other words, the dissipation value in Eq. 14 is relative in nature; i.e., the dissipation value of a single vehicle on its own isn't as useful as the dissipation values of a group of vehicles. All this means that a reasonable value for the mass (e.g., 2000 kg) can be used, and the results will be unaffected.

For each vehicle, the dissipation value can be calculated as given by Eq. 14. Once this is done, a frequency distribution of dissipation values can be made.

Most vehicles will have dissipation values that are close to each other—few vehicles will overuse/underuse their brakes relative to the majority. This results in a normal distribution of dissipation values as seen in FIG. 13. This distribution can be characterized by a mean μd and a standard deviation σ_{d}.

The next step is to map this distribution to another created from brake service data.

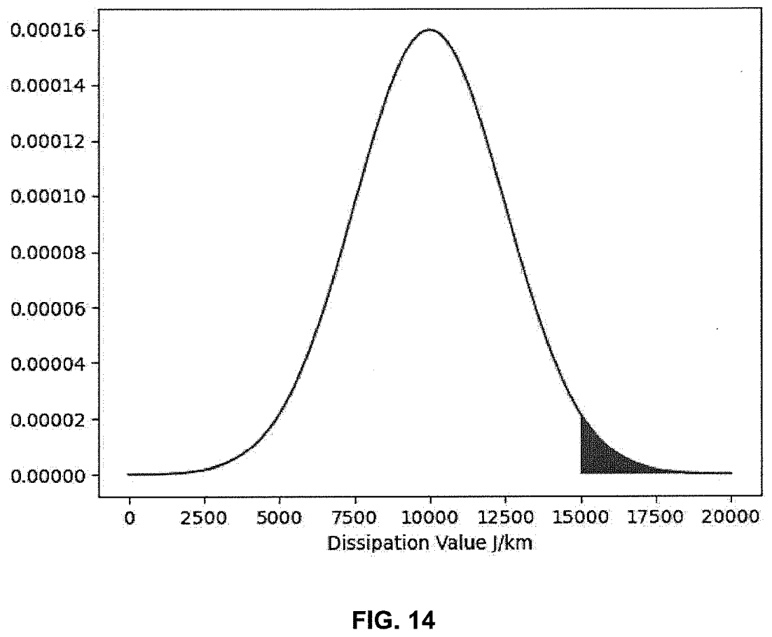

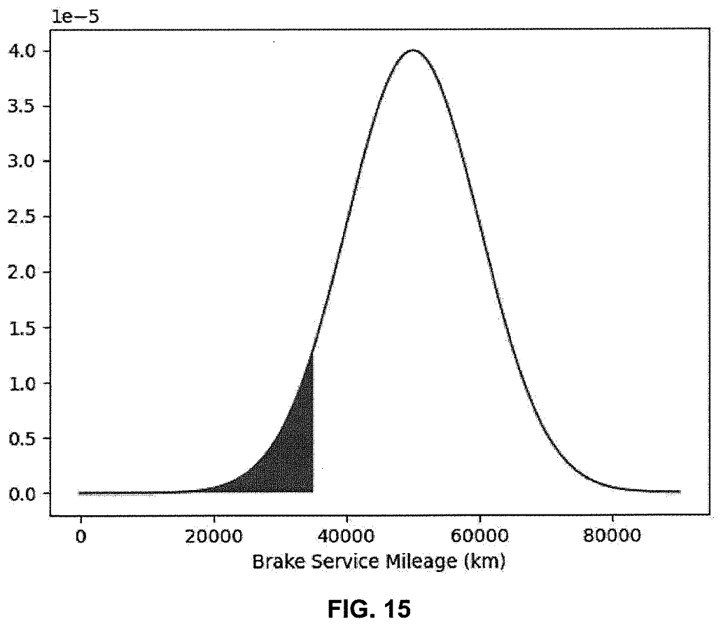

Each brake service/replacement performed on a vehicle is associated with a specific mileage—for example, the brake pads could be replaced at 50,000 km. If brake service records for a cohort of similar vehicles are considered, one would expect to see that most vehicles get brake services/replacements at around the same mileage. A few vehicles may get these earlier (lower mileage, higher brake wear) or later (higher mileage, lower brake wear). A frequency distribution of brake services with respect to mileage can then be made. FIG. 14 shows a distribution of dissipation values. FIG. 15 shows a distribution of brake service mileages, with the shaded region corresponding to the shaded region of FIG. 14.

This distribution is also characterized by a mean us and a standard deviation σₛ.

The distributions in FIGS. 14 and 15 are both normal (i.e. “Bell Curves”). Given two normal distributions, they can be compared easily. To do this, the Z-Score is used. Assuming a vehicle with a dissipation value xᵢ, the Z-score is given by:

$$Z = \frac{( {x}_{i} {μ}_{d} )}{{σ}_{d}} , \qquad ( 15 )$$

where μd is the mean and σd is the standard deviation of the distribution of dissipation values. The Z-score above indicates how many standard deviations away from the mean dissipation value any given dissipation value is.

Given a Z-score, Eq. 15 can be employed backwards to calculate xᵢ. In the case of the brake service distribution, one can use Eq. 15 (with an extra minus sign) to calculate the suggested mileage of a brake replacement, given the Z-score from the dissipation value distribution:

$$Z = \frac{- ( {y}_{i} {μ}_{s} )}{{σ}_{s}} . \qquad ( 16 )$$

Eq. 16 is identical in form to Eq. 15 except for the extra minus sign. This is needed because vehicles with a higher dissipation value will have higher brake wear and as a result will require a brake replacement at a lower mileage. This can be seen by looking at the shaded regions in FIGS. 14 and 15. The shaded region in FIG. 14 represents vehicles with relatively high dissipation values; i.e., high brake usage. As a result, the shaded region in FIG. 15 represents vehicles which have had earlier brake services.

The estimated mileage from the Z-score can then be shown to the user as a “suggested” brake replacement mileage.

The method described above is best applied to larger datasets. For PID data, the history may be six months or greater (in the case of a fleet vehicle driven five times a week). For service data, the amount of data available may include one or more brake replacements. While the model will still work with lower amounts, the accuracy may be affected due to the statistical nature of the model i.e. mapping Z-scores from distributions relies on reasonable amounts of data.

Another thing to note is that even without brake service data (and hence the brake service distribution), this model is still useful to a fleet manager as it does provide valuable information on which vehicles in a fleet have the highest and lowest brake usage.

The choice of the vehicle cohort is key and some form of cohort management system may ensure that brake usage data for all vehicles in a cohort are tracked over long periods of time.

These various approaches are used to generate a vehicle service event forecast that predicts a distribution of the time to failure for the vehicle.

One or more service events are then scheduled for the vehicle at least partially based on the objective function and the vehicle service event forecast.

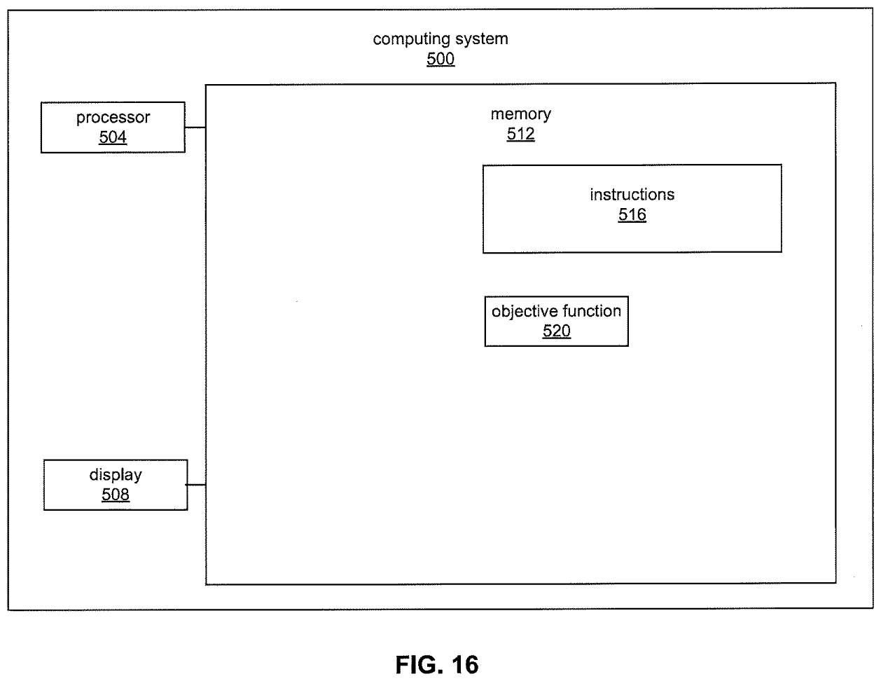

FIG. 16 shows various physical and logical components of an exemplary computing system 500 for objective-based scheduling of vehicle maintenance in accordance with an embodiment of the present disclosure. Although an example embodiment of the computing system 500 is shown and discussed below, other embodiments may be used to implement examples disclosed herein, which may include components different from those shown. Although FIG. 16 shows a single instance of each component of the computing system 500, there may be multiple instances of each component shown.

The computing system 500 includes one or more processors 504, such as a central processing unit, a microprocessor, an application-specific integrated circuit (ASIC), a field-programmable gate array (FPGA), a dedicated logic circuitry, a tensor processing unit, a neural processing unit, a dedicated artificial intelligence processing unit, or combinations thereof. The one or more processors 504 may collectively be referred to as a processor 504. The computing system 500 may include a display 508 for outputting data and/or information in some applications, but may not in some other applications.

The computing system 500 includes one or more memories 512 (collectively referred to as “memory 512”), which may include a volatile or non-volatile memory (e.g., a flash memory, a random access memory (RAM), and/or a read-only memory (ROM)). The non-transitory memory 512 may store machine-executable instructions for execution by the processor 504. A set of machine-executable instructions 516 defining a system for objective-based scheduling of vehicle maintenance (described herein) is shown stored in the memory 512, which may be executed by the processor 504 to perform the steps of the methods for scheduling vehicle maintenance described herein. The memory 512 may include other machine-executable instructions for execution by the processor 504, such as machine-executable instructions for implementing an operating system and other applications or functions.

In addition, the memory 512 stores or caches data for the fault code event record and the service event record in the database 40. This data can be stored permanently or retrieved in part or in whole as required from other systems.

Further, the memory stores an objective function 520 for the various objectives.

In some examples, the computing system 500 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the computing system 500) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 512 to implement data storage, retrieval, and caching functions of the computing system 500.

The components of the computing system 500 may communicate with each other via a bus, for example. In some embodiments, the computing system 500 is a distributed computing system and may include multiple computing devices in communication with each other over a network, as well as optionally one or more additional components. The various operations described herein may be performed by different computing devices of a distributed system in some embodiments. In some embodiments, the computing system 500 is a virtual machine provided by a cloud computing platform.

The steps (also referred to as operations) in the flowcharts and drawings described herein are for purposes of example only. There may be many variations to these steps/operations without departing from the teachings of the present disclosure. For instance, the steps may be performed in a differing order, or steps may be added, deleted, or modified, as appropriate.

### Reducing Badness

Different scenarios can be assigned a badness rating using a penalty function B(T(s), C(s)) where s is a scenario. This function may look at downtime T or money C, or a weighted combination of both, depending on the preferences of a fleet. Other factors may be considered, including but not limited to customer satisfaction, reputation, spare capacity, seasonal business trends, and others.

Usually the badness function will be a weighted function of time and money. When a fleet is time focused the time weighting will be large compared to the money weighting and vice versa. Badness functions will usually be linear in the variables, so that maxima and minima will be at the extreme (max/min) points, and there will not be any interior maxima. Without this assumption, more complex models would be necessary.

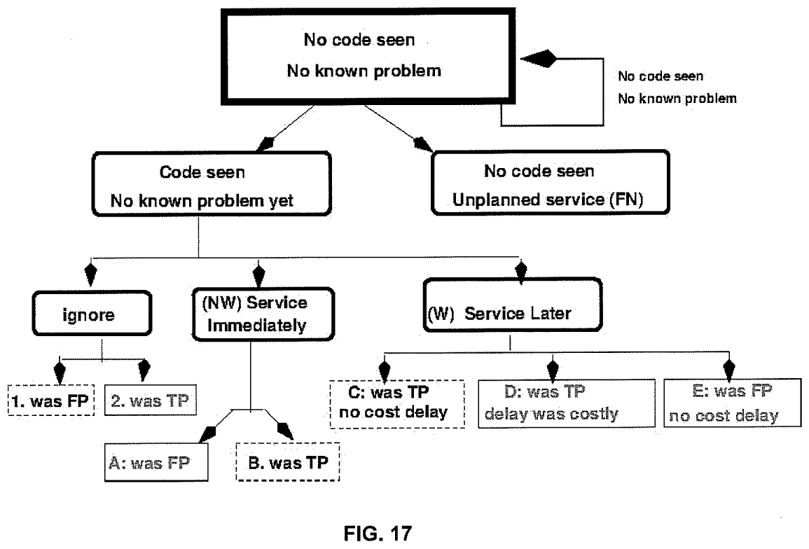

By choosing how we can respond in each scenario (FIG. 17) to get the least badness, we can assign a numerical priority rating for each DTC code. We will describe how to do this depending on each fleet, DTC code and its incidence and mean time to service.

### Decision Flow Chart and Case Counts

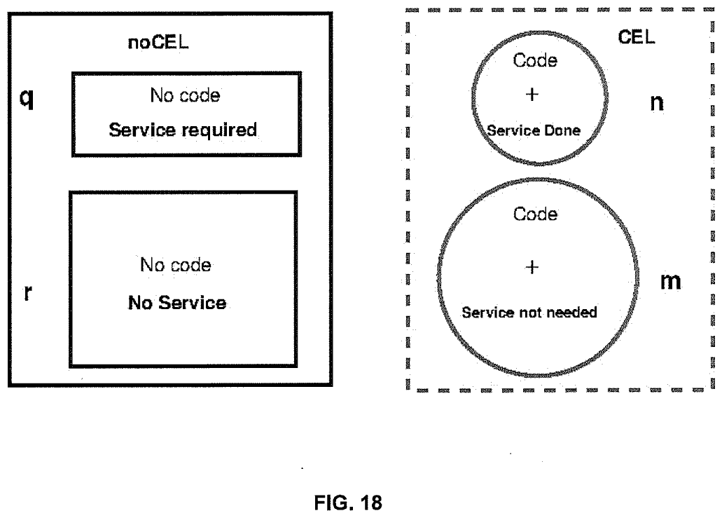

Briefly the decision to send a vehicle to the shop can be thought of in 2 steps. Refer to FIGS. 17 and 18.

In FIG. 17, scenarios are divided into those where a code occurred (or not) and those where a service was necessary (or not). Generally scenarios divide into those that depend on unchangeable events such as what problems develop with the vehicle, and how good a code is as a predictor, and those that are determined at least partly by decisions of the fleet manager (Ignore, Service Immediately (NW), Service Later (W)).

Final scenarios/outcomes may be labeled 1, 2, A, B, C, D, E as shown. Outcomes in solid boxes (2, A, D, E) are outcomes which we can control to some extent by improving decision making. However, because outcomes become visible only after the decision, policies only work on the average. TP refers to ‘true positive’ and FP to ‘false positive’.

In FIG. 18, scenarios are divided into those where a code occurred and those where a service was necessary. When combinations of these scenarios are counted, there are 4 cases. The letters q, r, n and m represent the numbers in each scenario, respectively. This is a general classification that can apply to any single code or group of codes. These categories are based on a code and service occurring sometime in the observation time window. Mean time to service (mTTS) is not considered in this figure.

We consider 2 groups of vehicles; those which showed the code and had no relevant service (noCEL) and those which showed the code and had a relevant service (CEL), where CEL (check engine light) labels vehicles showing a code.

The larger the CEL group is, compared to the noCEL group, the more powerful the code is in predicting service, since the noCEL group are false alarms. However, the code is still useful if the CEL group proportion within CEL+noCEL is higher than the rate of that service for vehicles that showed no warning.

The mTTS reflects the time from when the code triggered until the service event. Each type of code is a signal for a particular kind of breakdown. For the purposes of this section, ‘breakdown’ does not necessarily mean a dramatic event such as a tow, but encompasses an assessment that something should be done right away.

Thus, relevant services are taken as a proxy for breakdowns. The mean time to service (mTTS) is information about how risky it is to put off service. A short mTTS means problems may come soon, a long mTTS means the risk of putting off service is less. Therefore this measure can play a role in whether we recommend putting off services or doing it right away.

### Available Choices

As shown in FIG. 17 when a code is observed we can choose to
(i) do nothing or
(ii) wait 2 weeks
(iii) send the vehicle to the shop immediately.

Other choices can be included, for example deferring a repair to a next scheduled shop visit, which may occur within the next week, within 2 weeks, within 3 weeks, or in general within a time period that can be determined at the time of the code observation.

There is an expected cost to send the vehicle to the shop immediately, since it will be wrong a fraction m/N of the time. However, the longer we wait to send it to the shop, the greater the risk that the vehicle has a breakdown. The best choice can be found by comparing the badness rating for each scenario.

Effective costs associated with these risks can be measured using the badness function B( ) and the mean time to service (mTTS) statistic calculated from the record for each code. This will be illustrated by working through an example.

In this section, while general language from the probability domain is used, it is understood that probability is to be construed as the long run percentage of the event in question. So for example we write the expected badness as:

E(B)=P(scenario sA)B(scenario sA)+P(scenario sB)B(scenario sB)
provided scenario sA and scenario sB exhaust all possibilities, and refer to the relative percentage of scenario sA, P (scenario sA) as the probability of scenario A, and similarly for scenario sB. The notation E ( ) is the expected value, meaning a long term average.

Referring to FIG. 18, P (Service Done|code)=n/(n+m), is the probability of Service Done given a code.

The incidence of a code (DTC) is the percentage of vehicles that display the code, regardless of whether they had a problem or are serviced for it. The mean time to the relevant service service (mTTS) within a group is the mean time to the relevant service counting every trigger time. Let N=n+m+r+q. Then the code incidence is (n+m)/N.

### A Sample Calculation

We suppose out of 100 vehicles 7 have a certain code. It is known from previous analyses, that 3/7 will have a problem within 2 weeks, if they have a code. If there is no code only 1 will have a breakdown. Comparing with FIG. 18, q=1, r=92, n=3, m=4. Code incidence is 7/100.

Suppose the mean time to service for the code (mTTS) is 30 days.

TABLE 14
Contingencies

| Code | No breakdown | Breakdown |
|---|---|---|
| yes | 4 | 3 |
| no | 92 | 1 |

Then P(K|code)=3/7 and (1−P(K|code))=4/7. where K=breakdown event and P(x|y) is the conditional probability of x given y.

The mTTS is longer than 2 weeks because some codes get ignored for a while, or do not lead to breakdown. Then 1/mTTS is proportional to the risk of a breakdown (or found problem) per unit time. If we measure time in days, then the risk of a breakdown (or found problem) in 14 days is qW=0.5*14/mTTS=7/30 assuming a uniform distribution on [0, 2 mTTS], the probability of no breakdown in 14 days would then be 1−qW.

In this way, assign probabilities to the outcomes in FIG. 17.
A. Send to shop but no problem. Probability 1-P(K|code)
B. Send to shop and problem found. Probability P(K|code).
C. We wait and in the end a problem is fixed. Probability (1-qW) P(K|code)
D. We wait but have a breakdown in wait period. Probability=qW.
E. We wait and in the end there is no problem. Probability (1-qW) (1-P(K|code)).

Now we compute the expected badness of these cases, where we fill in some plausible numbers for scenario badness. Scenario badness may be determined based on received inputs, for example data collected via a web interface. The received inputs may include, but are not limited to, Annual Downtime Incidents, Average Downtime Duration per Incident, Average Cost of Downtime per Hour, Revenue Loss from Downtime, Annual Tow and Road Call Events, Average Cost of Towing Calls, Diagnostics Occurrences per Year per Vehicle, Average Labor Hours per Downtime Incident, Burdened Labor Rate ($), Time Spent for Diagnostics per Vehicle, and others. It is understood that badness numbers may also be received as ranked list of outcomes or in any other form suitable for processing into a numerical representation of the impact of an outcome.

Badness values may be ascribed to one or more scenarios by an algorithm, including but not limited to a Machine Learning Algorithm (MLA). For example, an MLA may be configured to ascribe a badness value to one or more scenarios based on data comprised in a knowledge base, including but not limited to cost data, downtime data, customer satisfaction data, worker and/or driver safety data, and others.

TABLE 15
Badness and probability of scenarios

| Sce- | | | | | Expected |
|---|---|---|---|---|---|
| nario | Comment | Badness | Pr formula | Probability | badness |
| A | (NW) was FP | 20 | 1 − | 4/7 | 11.42 |
| | | | P(K\|code) | | |
| B | (NW) was TP | 0 | P(K\|code) | 3/7 | 0 |
| C | (W) TP delay | 0 | (1 − qW) | (23/30) (3/7) | 0 |
| | no cost | | P(K\|code) | | |
| D | (W) TP delay | 50 | qW | 7/30 | 11.66 |
| | costly | | | | |
| E | (W) FP delay | 10 | 1 − qW | (23/30)(4/7) | 4.38 |
| | no cost | | | | |

Sum of the W (wait) scenarios C, D, E is 11.66+4.38+0=16.04.
Sum of the NW (do not wait) scenarios A, B is 11.42+0=11.42.

Since NW choices minimize expected badness, this code should be treated as critical or major and we should not wait.

Generally, a method to reduce badness involves receiving a fault code, or an indication thereof, and analysing the fault code to determine whether the vehicle should be repaired or examined at the shop immediately.

Badness data for potential outcomes and probabilities for potential outcomes, based on historical data, on received inputs, or on combinations thereof are used to compute a total badness score for each possible group of outcomes. In these examples, the groups comprised waiting and not waiting for a repair. It is understood that other groupings may be used, including but not limited to, for example, whether to use a third-party part or an original manufacturer one, whether to repair the vehicle in-house or outsource the work, adapting operating conditions, such as limiting a vehicle's speed or acceleration, and others.

An indication corresponding to the lowest badness group is then provided, for example to a user such as a driver or to fleet management personnel. It is understood that indications corresponding to more than one group analysed as above may be provided, i.e. the method may offer users information regarding the determined badness scores for two or more groups, allowing the user to make a choice. In the case of a driver, it is understood that a single indication may provide advantages such as reduced distraction while driving and reduced need to communicate with a central office with respect to a fault code. Accordingly, a driver may, for example, receive a notification to ignore a fault code, whether the check engine light is lit or not; or to report the fault code at the end of the day, or that the fault code has been logged and will be dealt with at a later date. When a fault code is critical, the driver may receive an indication to bring the vehicle for service immediately, for example a notification to cease deliveries and direct the vehicle to the nearest repair shop. For this purpose, a location-based repair shop search function may be integrated to the method to provide the driver with the name and/or address and/or directions to a repair shop, which may be selected based on one or more factors including, but not limited to, proximity, cost and/or affiliation.

### General

Through the descriptions of the preceding embodiments, the present invention may be implemented by using hardware only, or by using software and a necessary universal hardware platform, or by a combination of hardware and software. The coding of software for carrying out the above-described methods described is within the scope of a person of ordinary skill in the art having regard to the present disclosure. Based on such understandings, the technical solution of the present invention may be embodied in the form of a software product. The software 1440 product may be stored in a non-volatile or non-transitory storage medium, which can be an optical storage medium, flash drive or hard disk. The software product includes a number of instructions that enable a computing device (personal computer, server, or network device) to execute the methods provided in the embodiments of the present disclosure.

All values and sub-ranges within disclosed ranges are also disclosed. Also, although the systems, devices and processes disclosed and shown herein may comprise a specific plurality of elements, the systems, devices and assemblies may be modified to comprise additional or fewer of such elements. Although several example embodiments are described herein, modifications, adaptations, and other implementations are possible. For example, substitutions, additions, or modifications may be made to the elements illustrated in the drawings, and the example methods described herein may be modified by substituting, reordering, or adding steps to the disclosed methods.

Features from one or more of the above-described embodiments may be selected to create alternate embodiments comprised of a sub-combination of features which may not be explicitly described above. In addition, features from one or more of the above-described embodiments may be selected and combined to create alternate embodiments comprised of a combination of features which may not be explicitly described above. Features suitable for such combinations and sub-combinations would be readily apparent to persons skilled in the art upon review of the present disclosure as a whole.

In addition, numerous specific details are set forth to provide a thorough understanding of the example embodiments described herein. It will, however, be understood by those of ordinary skill in the art that the example embodiments described herein may be practiced without these specific details. Furthermore, well-known methods, procedures, and elements have not been described in detail so as not to obscure the example embodiments described herein. The subject matter described herein and in the recited claims intends to cover and embrace all suitable changes in technology.

Although the present invention and its advantages have been described in detail, it should be understood that various changes, substitutions and alterations can be made herein without departing from the invention as defined by the appended claims.

The present invention may be embodied in other specific forms without departing from the subject matter of the claims. The described example embodiments are to be considered in all respects as being only illustrative and not restrictive. The present disclosure intends to cover and embrace all suitable changes in technology. The scope of the present disclosure is, therefore, described by the appended claims rather than by the foregoing description. The scope of the claims should not be limited by the embodiments set forth in the examples, but should be given the broadest interpretation consistent with the description as a whole.

1. A computer-implemented method for objective-based scheduling of vehicle servicing, comprising:
storing an objective function for prioritizing vehicle availability and vehicle maintenance cost reduction;
receiving vehicle telematics data for a vehicle;
generating a vehicle service event forecast at least partially based on the vehicle telematics data; and
scheduling a vehicle service event for the vehicle related to the vehicle telematics data at least partially based on the vehicle service event forecast and the objective function.

2. The method of claim 1, wherein the vehicle telematics data includes one or more fault code events corresponding to one or more fault codes.

3. The method of claim 1, wherein the vehicle telematics data includes metrics indicative of wear of one or more components of the vehicle.

4. The method of claim 1, wherein the vehicle telematics data includes battery health data corresponding to a health state of a battery of the vehicle.

5. The method of claim 1, wherein the objective function is a weighted function of cost over time.

6. The method of claim 1, wherein the scheduling includes adjusting a scheduled service event for one or more issues identified in the vehicle telematics data.

7. The method of claim 6, wherein a check of a component associated with the issue is scheduled for the scheduled service event.

8. The method of claim 6, wherein the scheduled service event is scheduled earlier or later.

9. A computing system for objective-based scheduling of vehicle servicing, comprising:
one or more processors; and
a memory storing machine-executable instructions that, when executed by the one or more processors, cause the computing system to:
store an objective function for vehicle availability and vehicle maintenance cost reduction;
receive vehicle telematics data for a vehicle;
generate a vehicle service event forecast at least partially based on the vehicle telematics data; and
schedule a vehicle service event for the vehicle related to the vehicle telematics data at least partially based on the vehicle service event forecast and the objective function.

10. The computing system of claim 9, wherein the vehicle telematics data includes one or more fault code events corresponding to one or more fault codes.

11. The computing system of claim 9, wherein the vehicle telematics data includes at least one of:
metrics indicative of wear of one or more components of the vehicle; and
battery health data corresponding to a health state of a battery of the vehicle.

12. The computing system of claim 9, wherein the objective function is a weighted function of cost over time.

13. The computing system of claim 9, wherein the scheduling includes adjusting a scheduled service event for one or more issues identified in the vehicle telematics data.

14. The computing system of claim 13, wherein a check of a component associated with the issue is scheduled for the scheduled service event.

15. The computing system of claim 13, wherein the scheduled service event is scheduled earlier or later.

16. A non-transitory machine-readable medium having tangibly stored thereon executable instructions for execution by one or more processors, wherein the executable instructions, in response to execution by the one or more processors, cause the one or more processors to perform the method of claim 1.

17. A computer-implemented method for providing a vehicle service recommendation, comprising:
receiving a vehicle telemetric indication corresponding to a fault code;
receiving badness data for a plurality of outcomes associated to the fault code, each outcome being associated to one of a plurality of groups, the plurality of groups comprising at least:
a first group associated to a first action of a plurality of actions; and
a second group associated to a second action of the plurality of actions;
receiving, from a database, probability data corresponding to a probability of each outcome;
ascribing a badness value to each of the plurality of outcomes based on the badness data and the probability data;
determining a total badness score for at least the first group and the second group based on the badness value ascribed to each outcome;
determining a lowest badness group based on the total badness score; and
outputting an indication corresponding to the action, of the plurality of actions, associated to the lowest badness group, to provide the vehicle service recommendation.

18. The method of claim 17, wherein the receiving of the badness data comprises:
obtaining a plurality of indications, each indication corresponding to a numeric value and being associated to one of two or more badness factors, the badness factors comprising:
a cost of downtime associated to the fault code; and
a cost of repair associated to the fault code; and
storing the plurality of indications in the database.

19. The method of claim 17, wherein the plurality of actions comprises at least two of:
a vehicle repair action corresponding to executing a repair associated with the fault code;
a delay action corresponding to delaying the vehicle repair associated with the fault code for a predetermined time period; and
a defer action corresponding to executing the vehicle repair associated with the fault code during a scheduled shop visit.

20. A system for providing a vehicle service recommendation, the system comprising:
a processor; and
a non-transitory storage medium operatively connected to the processor, the non-transitory storage medium comprising computer readable instructions;
the processor, upon executing the computer readable instructions, being configured for performing the method of claim 17.
